(19) United States
(12) Patent Application Publication
(10) Pub. No.: US 2016/0212767 A1
(43) Pub. Date: Jul. 21, 2016

(54) SYSTEMS AND METHODS FOR CONTENTION ACCESS IN LICENSE ASSISTED ACCESS

(71) Applicant: Sharp Laboratories of America, Inc., Camas, WA (US)

(72) Inventors: Zhanping Yin, Vancouver, WA (US); Toshizo Nogami, Vancouver, WA (US)

(21) Appl. No.: 14/994,991

(22) Filed: Jan. 13, 2016

Related U.S. Application Data
(60) Provisional application No. 62/104,436, filed on Jan. 16, 2015.

(51) Int. Cl. H04W 74/08; H04W 24/08; H04W 72/04

(52) U.S. Cl. CPC H04W 74/08; H04W 72/0446; H04W 24/08

(57) ABSTRACT

A communication device is described. The communication device includes a processor and memory in electronic communication with the processor. Instructions stored in the memory are executable to configure a license-assisted-access (LAA) cell. The instructions are also executable to determine a region for CCA slots and contention access. The instructions are further executable to generate a backoff counter based on a contention window size N. The instructions are additionally executable to perform clear channel assessment (CCA) detection. The instructions are also executable to decrement the backoff counter if the channel is idle in a concerned one of the CCA slots. The instructions are further executable to transmit at least one subframe after the CCA slots if the backoff counter reaches zero within the region for CCA slots.

### RELATED APPLICATIONS

This application is related to and claims priority from U.S. Provisional Patent Application No. 62/104,436, entitled “SYSTEMS AND METHODS FOR CONTENTION ACCESS IN LICENSE ASSISTED ACCESS,” filed on Jan. 16, 2015, which is hereby incorporated by reference herein, in its entirety.

### TECHNICAL FIELD

The present disclosure relates generally to communication systems. More specifically, the present disclosure relates to systems and methods for licensed assisted access (LAA).

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### BRIEF DESCRIPTION OF THE DRAWINGS

FIG. 1 is a block diagram illustrating one implementation of one or more evolved NodeBs (eNBs) and one or more user equipments (UEs) in which systems and methods for licensed assisted access (LAA) may be implemented;

FIG. 2 is a flow diagram illustrating a method for timeslot structure in LAA by a UE;

FIG. 3 is a flow diagram illustrating a method for timeslot structure in LAA by an eNB;

FIG. 4 is a flow diagram illustrating a method for contention access in LAA by a UE;

FIG. 5 is a flow diagram illustrating a method for contention access in LAA by an eNB;

FIG. 6 illustrates an example of a LAA subframe burst transmission;

FIG. 7 illustrates an example of LAA coexistence with other unlicensed transmissions;

FIG. 8 illustrates packet exchange sequences of a successfully delivered 802.11 packet;

FIG. 9 illustrates the clear channel assessment (CCA) timeslot length and structure according to a first approach and a second approach;

FIG. 10 is a flow diagram illustrating a method for LAA transmitting node operations and state transitions;

FIG. 11 illustrates an example of LAA transmitting node state transitions;

FIG. 12 is a flow diagram illustrating a method for LAA receiving node operations and state transitions;

FIG. 13 illustrates a fixed contention access region and a dynamic backoff contention window;

FIG. 14 illustrates alternatives to apply a fixed contention access region and a dynamic backoff contention window;

FIG. 15 illustrates one implementation of an approach to contention access and backoff;

FIG. 16 illustrates various components that may be utilized in a UE;

FIG. 17 illustrates various components that may be utilized in an eNB;

FIG. 18 is a block diagram illustrating one implementation of a UE in which systems and methods for performing LAA may be implemented; and

FIG. 19 is a block diagram illustrating one implementation of an eNB in which systems and methods for performing LAA may be implemented.

### DETAILED DESCRIPTION

A communication device is described. The communication device includes a processor and memory in electronic communication with the processor. Instructions stored in the memory are executable to configure a license-assisted-access (LAA) cell. The instructions are also executable to determine a region for CCA slots and contention access. The instructions are further executable to generate a backoff counter based on a contention window size N. The instructions are additionally executable to perform clear channel assessment (CCA) detection. The instructions are also executable to decrement the backoff counter if the channel is idle in a concerned one of the CCA slots. The instructions are further executable to transmit at least one subframe after the CCA slots if the backoff counter reaches zero within the region for CCA slots.

The CCA slots may be located in k symbol(s) at an end of a subframe, k being either one of 1, 2, and 3. The number of the CCA slots within the region may be equal to N.

A method performed in a communication device is also described. The method includes configuring a license-assisted-access (LAA) cell. The method also includes determining a region for CCA slots and contention access. The method further includes generating a backoff counter based on a contention window size N. The method additionally includes performing clear channel assessment (CCA) detection. The method also includes decrementing the backoff counter if the channel is idle in a concerned one of the CCA slots. The method further includes transmitting at least one subframe after the CCA slots if the backoff counter reaches zero within the region for CCA slots.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and other standards (e.g., 3GPP Releases 8, 9, 10, 11 and/or 12). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In 3GPP specifications, a base station is typically referred to as a Node B, an evolved Node B (eNB), a home enhanced or evolved Node B (HeNB) or some other similar terminology. As the scope of the disclosure should not be limited to 3GPP standards, the terms “base station,” “Node B,” “eNB,” and “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB may also be more generally referred to as a base station device.

It should be noted that as used herein, a “cell” may refer to any set of communication channels over which the protocols for communication between a UE and eNB that may be specified by standardization or governed by regulatory bodies to be used for International Mobile Telecommunications-Advanced (IMT-Advanced) or its extensions and all of it or a subset of it may be adopted by 3GPP as licensed bands (e.g., frequency bands) to be used for communication between an eNB and a UE. “Configured cells” are those cells of which the UE is aware and is allowed by an eNB to transmit or receive information. “Configured cell(s)” may be serving cell(s). The UE may receive system information and perform the required measurements on all configured cells. “Activated cells” are those configured cells on which the UE is transmitting and receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

The systems and methods disclosed may involve carrier aggregation (CA). Carrier aggregation refers to the concurrent utilization of more than one carrier. In carrier aggregation, more than one cell may be aggregated to a UE. In one example, carrier aggregation may be used to increase the effective bandwidth available to a UE. The same time-division duplex (TDD) uplink-downlink (UL/DL) configuration has to be used for TDD CA in Release-10, and for intra-band CA in Release-11. In Release-11, inter-band TDD CA with different TDD UL/DL configurations is supported. The inter-band TDD CA with different TDD UL/DL configurations may provide the flexibility of a TDD network in CA deployment. Furthermore, enhanced interference management with traffic adaptation (eIMTA) (also referred to as dynamic UL/DL reconfiguration) may allow flexible TDD UL/DL reconfiguration based on the network traffic load.

It should be noted that the term “concurrent” and variations thereof as used herein may denote that two or more events may overlap each other in time and/or may occur near in time to each other. Additionally, “concurrent” and variations thereof may or may not mean that two or more events occur at precisely the same time.

Licensed-assisted access (LAA) may support LTE in unlicensed spectrum. In a LAA network, the DL transmission may be scheduled in an opportunistic manner. For fairness utilization, an LAA eNB may perform functions such as clear channel assessment (CCA), listen before talk (LBT) and dynamic frequency selection (DFS) before transmission. When the eNB performs LBT, the eNB cannot transmit any signals, including reference signals.

To perform contention channel access, some extended CCA (ECCA) mechanisms should be specified for a LAA node that can transmit UL signals. As used herein, a “LAA node” may be a LAA eNB or a LAA UE. To define an ECCA mechanism, the CCA timeslot needs to be specified first.

As described herein, the CCA timeslot size and structure for LAA are defined. Also methods to determine a contention access region for CCA detection are defined.

Furthermore, fairness with existing technologies, such as WiFi, is considered in the contention access mechanisms. Several access mechanisms for the contention window size determination and backoff algorithms are defined herein.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

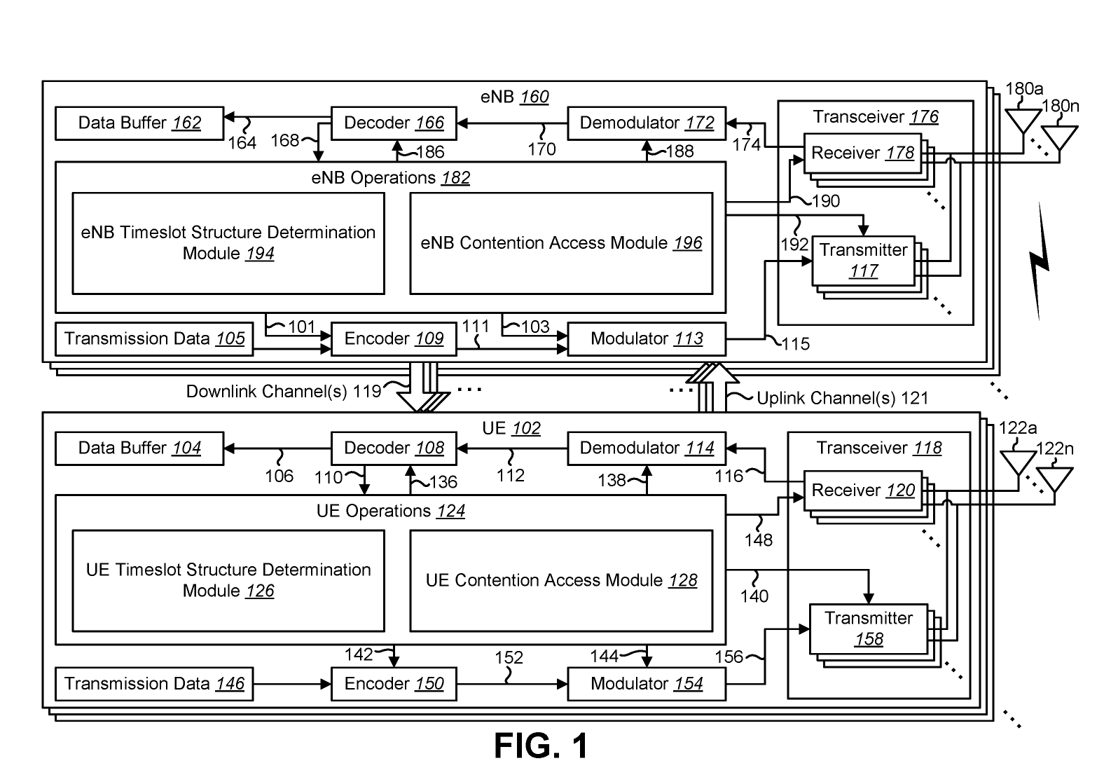

FIG. 1 is a block diagram illustrating one implementation of one or more eNBs 160 and one or more UEs 102 in which systems and methods for LAA may be implemented. The one or more UEs 102 communicate with one or more eNBs 160 using one or more antennas 122a-n. For example, a UE 102 transmits electromagnetic signals to the eNB 160 and receives electromagnetic signals from the eNB 160 using the one or more antennas 122a-n. The eNB 160 communicates with the UE 102 using one or more antennas 180a-n.

The UE 102 and the eNB 160 may use one or more channels 119, 121 to communicate with each other. For example, a UE 102 may transmit information or data to the eNB 160 using one or more uplink channels 121. Examples of uplink channels 121 include a PUCCH and a PUSCH, etc. The one or more eNBs 160 may also transmit information or data to the one or more UEs 102 using one or more downlink channels 119, for instance. Examples of downlink channels 119 include a PDCCH, a PDSCH, etc. Other kinds of channels may be used.

Each of the one or more UEs 102 may include one or more transceivers 118, one or more demodulators 114, one or more decoders 108, one or more encoders 150, one or more modulators 154, a data buffer 104 and a UE operations module 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals from the eNB 160 using one or more antennas 122a-n. For example, the receiver 120 may receive and downconvert signals to produce one or more received signals 116. The one or more received signals 116 may be provided to a demodulator 114. The one or more transmitters 158 may transmit signals to the eNB 160 using one or more antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce one or more decoded signals 106, 110. For example, a first UE-decoded signal 106 may comprise received payload data, which may be stored in a data buffer 104. A second UE-decoded signal 110 may comprise overhead data and/or control data. For example, the second UE-decoded signal 110 may provide data that may be used by the UE operations module 124 to perform one or more operations.

As used herein, the term “module” may mean that a particular element or component may be implemented in hardware, software or a combination of hardware and software. However, it should be noted that any element denoted as a “module” herein may alternatively be implemented in hardware. For example, the UE operations module 124 may be implemented in hardware, software or a combination of both.

In general, the UE operations module 124 may enable the UE 102 to communicate with the one or more eNBs 160. The UE operations module 124 may include one or more of a UE timeslot structure determination module 126 and a UE contention access module 128.

The Licensed-Assisted Access (LAA) in an unlicensed band for LTE (also referred to as LTE unlicensed or unlicensed LTE) allows opportunistic usage of unlicensed carrier for LTE transmissions.

In one implementation, only DL LAA is performed. However, in another implementation, both UL and DL transmission may be performed. Thus, a LAA UE 102 and eNB 160 may transmit UL and/or receive signals on one or more unlicensed carriers in an opportunistic way.

As used herein, the term “LAA node” may refer to a LAA eNB 160 that performs DL transmissions in unlicensed carriers or a LAA UE 102 that supports UL transmissions in unlicensed carriers.

The LAA transmission is assisted with a licensed band. Carrier aggregation (CA) is one operation that may be performed with an unlicensed LAA cell operating with a licensed LTE cell. With CA, the radio frame (e.g., the system frame number (SFN)) may be synchronized across all serving cells. Furthermore, the subframe indexes may also be synchronized. In a CA case, the maximum time alignment (TA) differences among serving cells is 33 microseconds.

In an LAA network, a DL or UL transmission may be scheduled in an opportunistic manner. For fairness utilization, a LAA node (e.g., a LAA eNB or a LAA UE) is required to perform some functions (e.g. clear channel assessment (CCA), listen before talk (LBT)) before any transmission. Thus, a LAA transmission cannot guarantee a transmission at fixed subframe boundaries.

Therefore, a first LAA subframe transmission may need to perform carrier sensing, and if there is no ongoing transmissions, the LAA subframe may be transmitted. Otherwise, the LAA node should defer the transmission and perform clear channel assessment (CCA) again at the next contention access region.

In LAA, the serving cell should be synchronized with a licensed cell. The time used for carrier sensing and CCA will be removed from the first LAA subframe transmission.

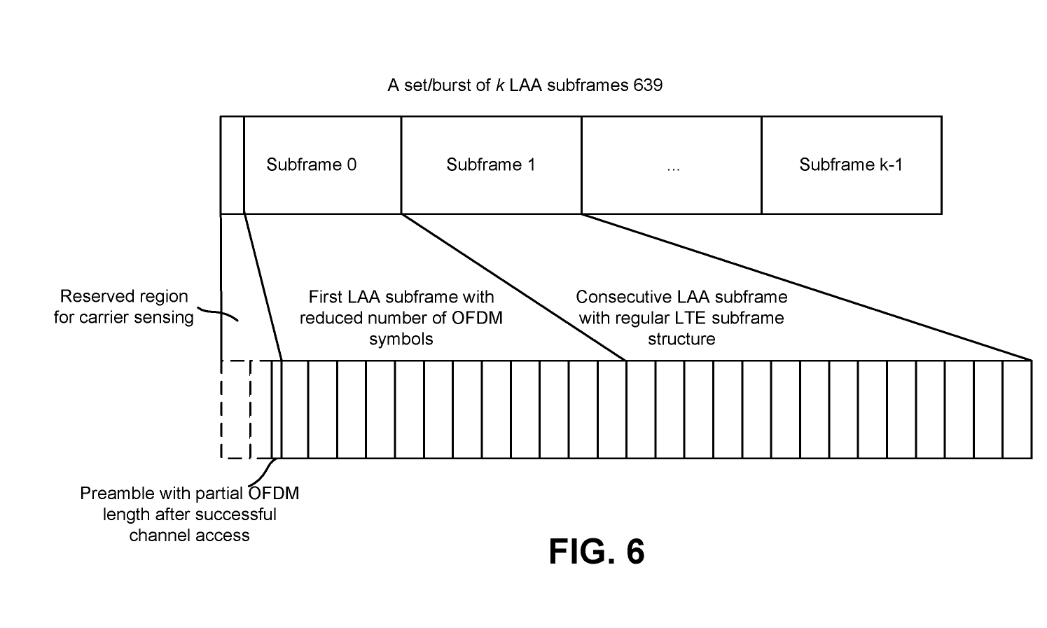

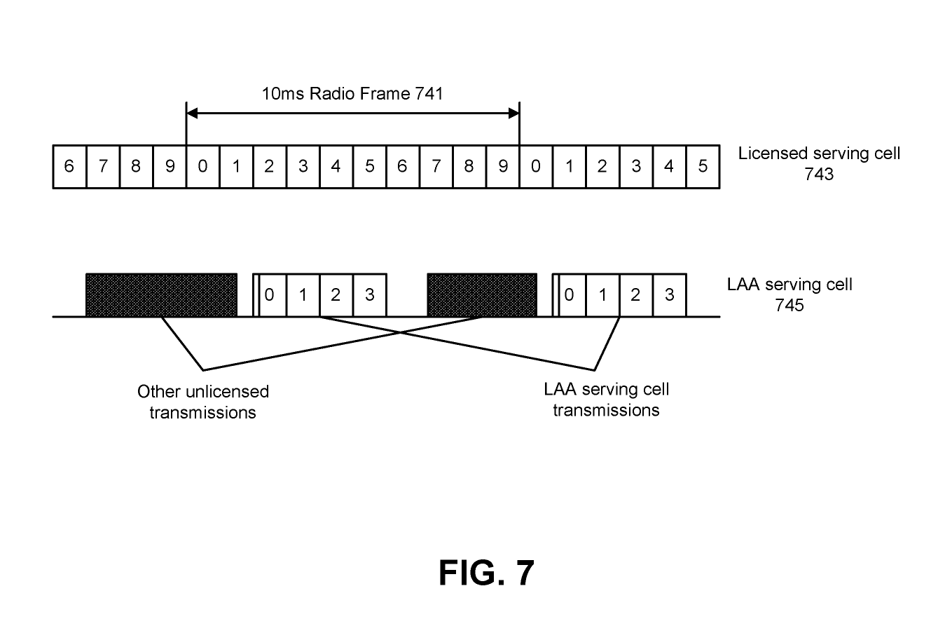

To provide fairness to other networks on the same unlicensed carrier, the eNB 160 may configure a maximum number of continuous subframe transmissions k in a LAA cell (i.e., a set of LAA subframes or a burst of LAA subframes). The maximum transmission time in an unlicensed carrier may be different in different regions and/or countries based on the regulatory requirements. For example, the maximum transmission time of an unlicensed transmission in Japan is approximately 4 milliseconds (ms); the maximum transmission time of an unlicensed transmission in Europe is 10 ms. Therefore, in one approach, the maximum number of continuous subframe transmissions k may be implicitly determined by the region/country regulator requirement. In another approach, the maximum number of continuous subframe transmissions k may be explicitly configured by higher layer signaling. An example of a subframe set transmission is discussed in connection with FIG. 6. An example of LAA coexistence with other unlicensed transmissions is described in connection with FIG. 7.

The UE timeslot structure determination module 126 may determine the clear channel assessment (CCA) timeslot size and/or structure of the unlicensed LAA cell. To avoid interruption to ongoing WiFi signals, different CCA lengths may be specified. As used herein, a slot for CCA detection is referred as a CCA slot or a CCA timeslot. An initial CCA length may be long enough to avoid interruption of a WiFi signal transmission. The consecutive CCA timeslots may be much shorter to provide fairness sharing with WiFi signals. A short CCA timeslot may be used to perform channel access (e.g., backoff mechanisms).

In one implementation, different lengths may be defined for a long initial CCA timeslot and a short CCA timeslot. In another implementation, only one CCA timeslot length is defined, and the initial CCA timeslot consists of multiple CCA timeslots. In yet another implementation, only one CCA timeslot length is defined for LAA operations, and the CCA timeslot length is longer than a short interframe space (SIFS) in 802.11. Thus, the LAA can avoid interruption of an ongoing 802.11 packet exchange. On the other hand, because the CCA slot size is longer than the backoff slot size of 802.11, an LAA node may have less channel access probability compared with 802.11 stations in the same unlicensed carrier.

The backoff timeslot in 802.11-based WiFi systems is not synchronized and starts after a distributed interframe space (DIFS) gap after a packet transmission. For a synchronized LAA network, the CCA slot size may be defined based on a fraction of an Orthogonal Frequency Division Multiplexed (OFDM) symbol length. Thus, the CCA timeslot may be well defined within a subframe structure. This avoids a random backoff slot location and the need to transmit fractional symbols with a random length.

The UE timeslot structure determination module 126 may further determine a contention access region of the LAA cell. In a first approach for defining a contention access region in LAA, the contention access region may start at any time in a subframe with any length. In a second approach, the contention access region may be at fixed or configured locations in a subframe. In a third approach for defining a contention access region in LAA, the contention access region is at a fixed or configured length after the channel is clear for a long initial CCA timeslot.

A UE contention access module 128 may perform contention access procedures. The WiFi 802.11 protocol considers a large number of stations contending for channel access. Thus, an exponential backoff function may be used. In LAA, especially for DL-only LAA systems, the number of LAA nodes contending for access is much smaller than in WiFi 802.11 systems.

Since the slot size of LAA and WiFi may have a different length, different content access mechanisms may be used to provide fairness of contention access. Some factors that may be considered for the backoff algorithms include the contention window size, the backoff counter countdown, and the backoff slot size.

The UE contention access module 128 may perform contention access with a backoff protocol when the channel becomes IDLE. In a first approach, the UE contention access module 128 may perform a random backoff from any CCA slots with predefined contention window sizes. In this approach, backoff algorithms with a fixed contention window (CW) size or an exponential CW size may be applied. The initial CW size and maximum CW size may be specified to provide fair contention with 802.11. However, this requires a LAA node to support a new fractional OFDM symbol length signal transmission, and support a random number of OFDM symbols in a subframe.

In a second approach, the UE contention access module 128 may perform a random backoff with a dynamic contention window size in a reserved contention access region. In this approach, the LAA subframe structure can be defined with a fixed initial or last LAA subframe structure with a reserved contention access region. The access region may be a fixed length after the channel becomes IDLE. The CW size for backoff may be dynamically determined based on the number of CCA timeslots from the time the channel is IDLE to the end of the contention access region. The CW size for backoff may be a fixed value based on the length of the contention access region. Although this approach requires a LAA node to support new fractional OFDM symbol length signal transmissions, the number of OFDM symbols in a subframe is well-defined.

In a third approach, the UE contention access module 128 may use a separate CCA timeslot and backoff transmission timeslot size. The CCA detection may be performed based on a CCA timeslot. In order to avoid a fractional OFDM symbol length signal transmission, the transmission may only start at an OFDM symbol boundary. Thus, the backoff counter and backoff size are based on the length of the OFDM symbol instead of the length of CCA timeslot.

The UE operations module 124 may provide information 148 to the one or more receivers 120. For example, the UE operations module 124 may inform the receiver(s) 120 when to receive retransmissions.

The UE operations module 124 may provide information 138 to the demodulator 114. For example, the UE operations module 124 may inform the demodulator 114 of a modulation pattern anticipated for transmissions from the eNB 160.

The UE operations module 124 may provide information 136 to the decoder 108. For example, the UE operations module 124 may inform the decoder 108 of an anticipated encoding for transmissions from the eNB 160.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142. The other information 142 may include PDSCH HARQ-ACK information.

The encoder 150 may encode transmission data 146 and/or other information 142 provided by the UE operations module 124. For example, encoding the data 146 and/or other information 142 may involve error detection and/or correction coding, mapping data to space, time and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the eNB 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the eNB 160. For instance, the one or more transmitters 158 may transmit during a UL subframe. The one or more transmitters 158 may upconvert and transmit the modulated signal(s) 156 to one or more eNBs 160.

The eNB 160 may include one or more transceivers 176, one or more demodulators 172, one or more decoders 166, one or more encoders 109, one or more modulators 113, a data buffer 162 and an eNB operations module 182. For example, one or more reception and/or transmission paths may be implemented in an eNB 160. For convenience, only a single transceiver 176, decoder 166, demodulator 172, encoder 109 and modulator 113 are illustrated in the eNB 160, though multiple parallel elements (e.g., transceivers 176, decoders 166, demodulators 172, encoders 109 and modulators 113) may be implemented.

The transceiver 176 may include one or more receivers 178 and one or more transmitters 117. The one or more receivers 178 may receive signals from the UE 102 using one or more antennas 180a-n. For example, the receiver 178 may receive and downconvert signals to produce one or more received signals 174. The one or more received signals 174 may be provided to a demodulator 172. The one or more transmitters 117 may transmit signals to the UE 102 using one or more antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The eNB 160 may use the decoder 166 to decode signals. The decoder 166 may produce one or more decoded signals 164, 168. For example, a first eNB-decoded signal 164 may comprise received payload data, which may be stored in a data buffer 162. A second eNB-decoded signal 168 may comprise overhead data and/or control data. For example, the second eNB-decoded signal 168 may provide data (e.g., PDSCH HARQ-ACK information) that may be used by the eNB operations module 182 to perform one or more operations.

In general, the eNB operations module 182 may enable the eNB 160 to communicate with the one or more UEs 102. The eNB operations module 182 may include one or more of an eNB timeslot structure determination module 194 and an eNB contention access module 196.

The eNB timeslot structure determination module 194 may determine the clear channel assessment (CCA) timeslot size and/or structure of the unlicensed LAA cell. This may be accomplished as described above.

The eNB contention access module 196 may perform contention access procedures. This may be accomplished as described above.

The eNB operations module 182 may provide information 188 to the demodulator 172. For example, the eNB operations module 182 may inform the demodulator 172 of a modulation pattern anticipated for transmissions from the UE(s) 102.

The eNB operations module 182 may provide information 186 to the decoder 166. For example, the eNB operations module 182 may inform the decoder 166 of an anticipated encoding for transmissions from the UE(s) 102.

The eNB operations module 182 may provide information 101 to the encoder 109. The information 101 may include data to be encoded and/or instructions for encoding. For example, the eNB operations module 182 may instruct the encoder 109 to encode transmission data 105 and/or other information 101.

The encoder 109 may encode transmission data 105 and/or other information 101 provided by the eNB operations module 182. For example, encoding the data 105 and/or other information 101 may involve error detection and/or correction coding, mapping data to space, time and/or frequency resources for transmission, multiplexing, etc. The encoder 109 may provide encoded data 111 to the modulator 113. The transmission data 105 may include network data to be relayed to the UE 102.

The eNB operations module 182 may provide information 103 to the modulator 113. This information 103 may include instructions for the modulator 113. For example, the eNB operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The eNB operations module 182 may provide information 192 to the one or more transmitters 117. This information 192 may include instructions for the one or more transmitters 117. For example, the eNB operations module 182 may instruct the one or more transmitters 117 when to (or when not to) transmit a signal to the UE(s) 102. The one or more transmitters 117 may upconvert and transmit the modulated signal(s) 115 to one or more UEs 102.

It should be noted that a DL subframe may be transmitted from the eNB 160 to one or more UEs 102 and that a UL subframe may be transmitted from one or more UEs 102 to the eNB 160. Furthermore, both the eNB 160 and the one or more UEs 102 may transmit data in a standard special subframe.

It should also be noted that one or more of the elements or parts thereof included in the eNB(s) 160 and UE(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

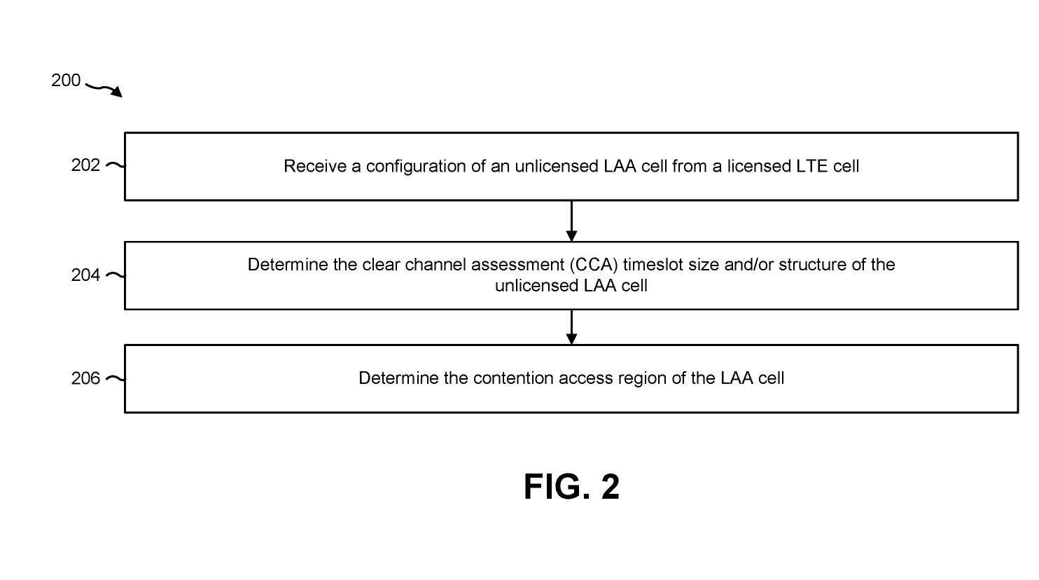

FIG. 2 is a flow diagram illustrating a method 200 for timeslot structure in LAA by a UE 102. The UE 102 may communicate with one or more eNBs 160 in a wireless communication network. In one implementation, the wireless communication network may include an LTE network. The UE 102 may receive 202 a configuration of an unlicensed LAA cell from a licensed LTE cell.

The UE 102 may determine 204 the clear channel assessment (CCA) timeslot size and/or structure of the unlicensed LAA cell. Before performing LBT and CCA and applying any backoff algorithms, the CCA timeslot size for LAA channel contention access may be defined first. A backoff algorithm is a mechanism for a node to perform contention access by selecting a time delay randomly or by determining whether to transmit or not based on a probability function.

In one approach, the CCA timeslot length can be a fixed value (e.g., 10 microseconds or 20 microseconds), and may be used for LAA channel access. However, this approach has several problems. If the value is too small, an LAA node may start transmission during an ongoing 802.11 packet exchange, thus interrupting normal WiFi operation. If the value is too large, the channel access probability is reduced compared with 802.11 stations.

To avoid interruption of ongoing packet transmissions in 802.11 networks, and to consider fairness for channel access between LAA and legacy unlicensed band technologies, several CCA timeslot lengths may be specified for the initial channel access and backoff slots. Alternatively, only one CCA timeslot length may be defined, and the initial CCA timeslot may include multiple CCA timeslots (e.g., sub-timeslots).

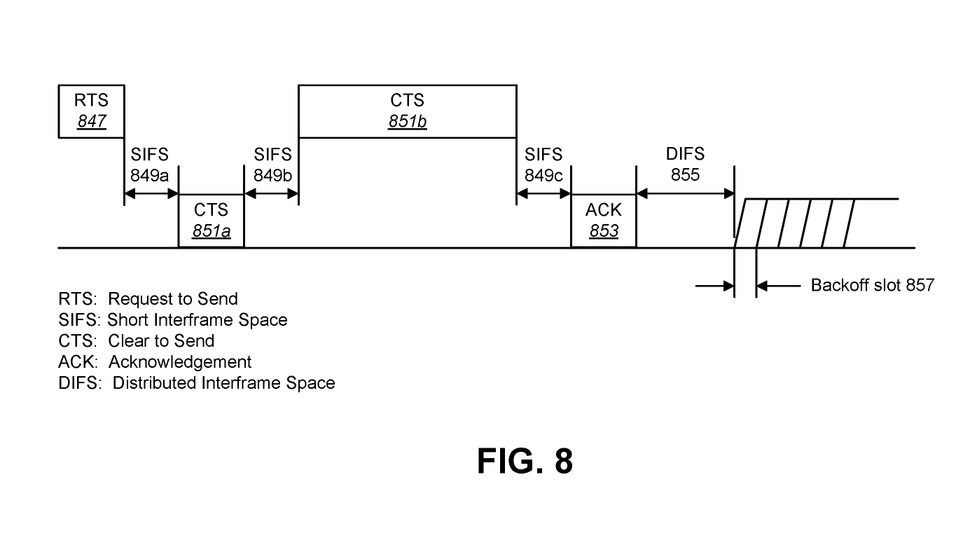

The initial CCA timeslot length may be defined. In 802.11 protocols used for WiFi transmissions, a short interframe space (SIFS) may be used between consecutive packet transmissions (e.g., between a packet and the ACK corresponding to it). The length of SIFS in a 5 GHz band is 16 microseconds. Furthermore, all 802.11 stations have to wait for a distributed interframe space (DIFS) before performing a backoff algorithm for channel access. FIG. 8 below illustrates packet exchange sequences of a successfully delivered 802.11 packet with the distributed coordination function (DCF) when a request to send (RTS) and clear to send (CTS) is used.

To avoid interruption of the 802.11 packet transmission protocol, the initial CCA timeslot for LAA may not be smaller than a SIFS. Furthermore, to provide fairness with 802.11, the initial CCA timeslot should be at least the length of a DIFS.

In 802.11 at the 5 GHz band, the SIFS is 16 microseconds, and a DIFS is 34 microseconds. The DIFS length is determined by SIFS plus two backoff timeslots (Tslot), where the Tslot is 9 microseconds in 5 GHz band 802.11 systems.

Thus, for LAA, the initial CCA timeslot length should be at least 16 microseconds to avoid interruption of 802.11 transmissions. Alternatively, for LAA, the initial CCA timeslot length should be at least 34 microseconds to have fairness contention with 802.11 stations. In other words, the LAA nodes may not start channel access earlier than the 802.11 stations in the same carrier.

The channel access slot length may also be defined. The channel access slot may be referred to as a backoff timeslot. The channel access slot may be a CCA timeslot in LAA. In 802.11 at 5 GHz band, the channel access backoff starts a DIFS after a packet transmission, the channel access slot (i.e., the backoff timeslot Tslot), has a length of 9 microseconds. Similarly, after the initial CCA timeslot, a shortened CCA timeslot can be applied in the extended CCA period for opportunistic usage of the channel with a backoff algorithm.

In 802.11-based WiFi, the CCA detection time is smaller than or equal to 4 microseconds. For LAA, the backoff timeslot may be determined by the required time for CCA detection. If different signal detection methods are applied in LAA, LAA may require a longer CCA detection time. Thus, LAA may have a longer CCA timeslot length.

A variety of values can be considered for the CCA backoff timeslot length in LAA. One value for the CCA backoff timeslot length is 9 microseconds. This value is the same as the 802.11 backoff timeslot. This value may provide better fairness for contention access.

Another value for the CCA backoff timeslot length is 16 microseconds. This is the same length of SIFS of 802.11 in the 5 GHz band. Thus, this value can avoid interruption of an ongoing 802.11 packet exchange.

Yet another value for the CCA backoff timeslot length is 20 microseconds. This value may provide for better CCA detection accuracy. It should be noted that this length is the same as the total length of 802.11 preamble and physical layer convergence protocol (PLPC) header.

Although any of the values given above can be used on a CCA timeslot, the nature of unsynchronized transmissions from legacy 802.11-based networks and other unsynchronized LAA networks makes the CCA timeslots unsynchronized too. This unsynchronized timeslot structure may make the LAA transmission and reception very complicated because a signal may start at any time.

The backoff timeslot in 802.11-based WiFi systems is not synchronized and starts after a DIFS gap after a packet transmission. Since the unlicensed transmission in 802.11 WiFi does not have a synchronized frame structure, the transmission may start and end at any time. If the same approach is used for LAA and the CCA timeslot is right after a channel busy period, the start time of a backoff timeslot may be a random length. For LAA, this is quite challenging.

The current LTE signals are transmitted as OFDM symbols, and no partial OFDM symbol transmission is supported. To make sure a LAA node can start or end transmission at any given time, special preambles or postambles may be used. However, designing a random length preamble is not practical and may be difficult for UEs 102 to detect.

LTE has a well synchronized frame structure. To simplify the system design, the LAA sensing slots can also be fully synchronized. In the LTE subframe structure, each radio frame is T_{f}=307200·Tₛ=10 ms long. Each subframe is 1 ms long and includes 2 slots of length Tₛₗₒₜ=15360·Tₛ=0.5 ms. Depending on the length of a cyclic prefix (CP), each slot may contain 6 or 7 OFDM symbols for extended CP and normal CP length. Thus, once the cell is activated and synchronized, the radio frame, subframe, slot and OFDM symbol boundaries are well defined.

For a synchronized LAA network, the CCA slot size should be defined based on a fraction of the OFDM symbol length, and the CCA timeslot can be well defined within a subframe structure. This avoids a random backoff slot location and the need to transmit fractional symbols with random length.

A synchronized LAA CCA timeslot structure may be defined as described herein. In this structure, the CCA timeslot length may be a fraction of an OFDM symbol length. In other words, an OFDM symbol may be divided into multiple CCA timeslots. A short CCA timeslot may be the smallest fraction of an OFDM symbol (e.g., 4, 8 or 16 short CCA timeslots may be in an OFDM symbol length). A long CCA timeslot (e.g., the initial CCA timeslot) may include multiple short CCA timeslots (e.g., 2, 4, or 8 short CCA timeslots).

It should be noted that the OFDM symbol might not have to be equally divided. The same benefit can be provided by one OFDM symbol or two including multiple short CCA timeslots, each of which has a comparable time length.

For a normal CP, an OFDM symbol length is 2208·Tₛ for the first OFDM symbol in a slot and 2192·Tₛ for the other OFDM symbols. In a first approach to an LAA CCA timeslot structure with a normal CP, a short CCA timeslot (i.e., a backoff CCA slot) is defined as ⅛ of an OFDM symbol length (i.e., 276·Tₛ) for the first OFDM symbol in a slot. The short CCA timeslot may be 274·Tₛ for the other OFDM symbols. In this case, the short CCA timeslot is approximately 9 microseconds. This is the same as the backoff slot time of 802.11 in 5 GHz band.

In one alternative of the first approach, the long CCA timeslot (i.e., the initial CCA timeslot) may be 4 times the short CCA timeslot (i.e., half of an OFDM symbol length or 1104·Tₛ) for the first OFDM symbol in a slot. The long CCA timeslot may be 1096·Tₛ for the other OFDM symbols. Therefore, the long CCA timeslot may be approximately, 35.7 microseconds.

In another alternative of the first approach, the long CCA timeslot (i.e. the initial CCA timeslot) may be 2 times the short CCA timeslot (i.e., ¼ of an OFDM symbol length or 552·Tₛ) for the first OFDM symbol in a slot. The long CCA timeslot may be 548·Tₛ for the other OFDM symbols. In this alternative, the long CCA timeslot is approximately 18 microseconds.

In a second approach to an LAA CCA timeslot structure with a normal CP, the CCA detection time may be longer. In this case, a short CCA timeslot (i.e., backoff CCA slot) may be defined as ¼ of an OFDM symbol length (i.e., 552·Tₛ) for the first OFDM symbol in a slot. The short CCA timeslot may be 548·Tₛ for the other OFDM symbols. Therefore, the short CCA timeslot is approximately 18 microseconds.

In one alternative, the long CCA timeslot (i.e., the initial CCA timeslot) may be 2 times the short CCA timeslot (i.e., one half of an OFDM symbol length or 1104·Tₛ) for the first OFDM symbol in a slot. The long CCA timeslot may be 1096·Tₛ for the other OFDM symbols. Therefore, in this alternative, the long CCA timeslot is approximately, 35.7 microseconds.

In another alternative, the long CCA timeslot (i.e., the initial CCA timeslot) may be the same as the short CCA timeslot. In other words, the long CCA timeslot may be half of an OFDM symbol length (i.e., 552·Tₛ) for the first OFDM symbol in a slot. The long CCA timeslot may be 548·Tₛ for the other OFDM symbols. In this alternative, the long CCA timeslot is approximately 18 microseconds.

In yet another alternative, the same short CCA length as the second to the last OFDM symbols in a slot may also be used in the first OFDM symbol instead of the above lengths.

For an extended CP, an OFDM symbol is 2560·Tₛ. In a first approach to an LAA CCA timeslot structure with an extended CP, a short CCA timeslot (i.e., backoff CCA slot) is defined as ⅛ of an OFDM symbol length (i.e., 320·Tₛ). Therefore, the short CCA timeslot in this approach is approximately 10.4 microseconds.

In one alternative, the long CCA timeslot (i.e., the initial CCA timeslot) is 4 times the short CCA timeslot, which is half of an OFDM symbol length (i.e., 1280·Tₛ). Therefore, the long CCA timeslot is approximately 41.70 microseconds.

In another alternative, the long CCA timeslot (i.e., the initial CCA timeslot) is 2 times the short CCA timeslot, which is ¼ of an OFDM symbol length (i.e., 640·Tₛ). Therefore, the long CCA timeslot is approximately 20.8 microseconds.

In a second approach to an LAA CCA timeslot structure with an extended CP, the CCA detection time may be longer. In this approach, the short CCA timeslot (i.e., the backoff CCA slot) may be defined as ¼ of an OFDM symbol length (i.e., 640·Tₛ). Therefore, the short CCA timeslot is approximately 20.8 microseconds.

In one alternative, the long CCA timeslot (i.e., the initial CCA timeslot) is 2 times the short CCA timeslot, which is half of an OFDM symbol length (i.e., 1280·Tₛ). Therefore, the long CCA timeslot is approximately 41.70 microseconds.

In another alternative, the long CCA timeslot (i.e., the initial CCA timeslot) is the same as the short CCA timeslot. In other words, the long CCA timeslot may be ¼ of an OFDM symbol length (i.e., 640·Tₛ). In this case, the long CCA timeslot is approximately 20.8 microseconds.

In a third approach to an LAA CCA timeslot structure with an extended CP, the CCA timeslot size may be configured by higher layer signaling and is selected from a set of backoff timeslot lengths.

In an area where a LAA cell coexists with 802.11-based WiFi networks, the CCA timeslot may be at least the length of SIFS to avoid interruption of a packet exchange in a WiFi transmission. Thus, with a synchronized CCA timeslot structure, the CCA timeslot may be defined as ¼ of an OFDM symbol length, which is the same as the short CCA timeslot in the second approaches to the LAA CCA timeslot structure (e.g., both normal CP and extended CP) described above.

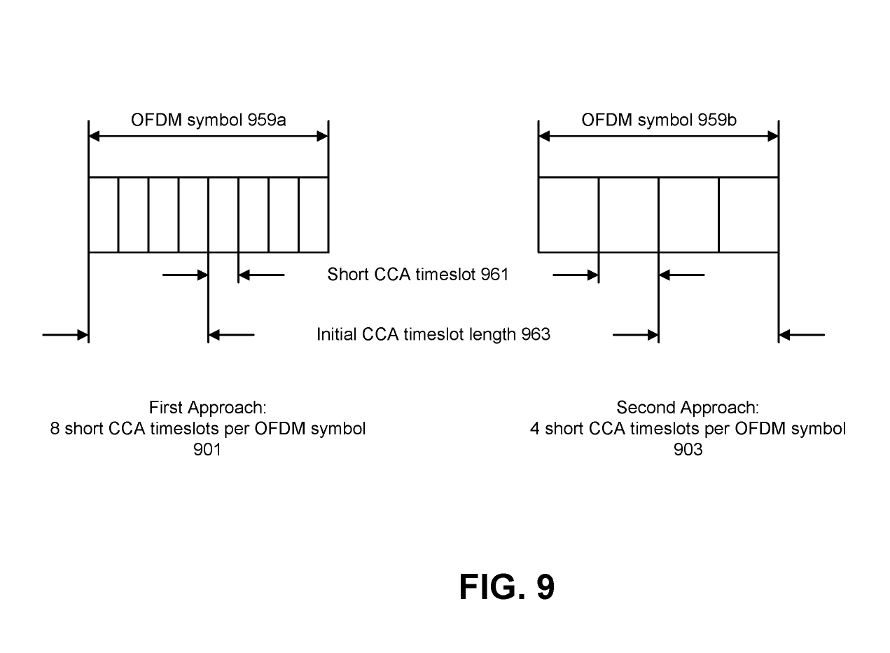

In an area where the LAA cell coexists with other LAA cells only and there are no 802.11-based WiFi networks, the CCA timeslot may be shorter than SIFS. Thus, with a synchronized CCA timeslot structure, the CCA timeslot may be defined as ⅛ of an OFDM symbol length, which is the same as the short CCA timeslot in the first approaches to the LAA CCA timeslot structure (e.g., both normal CP and extended CP) described above. FIG. 9 illustrates the CCA timeslot length and structure according to the first and second approaches described above.

There are several benefits of a simplified LAA CCA timeslot. The location of a slot may be known to all LAA UEs 102, which simplifies CCA detection. Additionally, when an LAA node gets the channel, it may start in the middle of an OFDM symbol length. In this case, the synchronized structure may require only a limited number of preambles to be specified for a partial OFDM symbol transmission.

The described CCA timeslot and synchronized structure may be applied to a LAA node in both a DL-only LAA cell and a LAA cell that supports both DL and UL transmissions. In a DL-only LAA cell, the CCA timeslot and structure are based on the DL subframe timing at both the LAA eNB 160 and the LAA UE 102.

In a LAA cell that supports DL and UL transmission, the UE 102 needs to adjust the UL transmissions with a timing advance (TA) value. The TA may be used to align the received uplink transmissions with the DL subframe boundary at the eNB 160. Thus, for a LAA eNB 160, the CCA timeslot and structure are based on the DL subframe timing. For a LAA UE 102, the CCA timeslot for DL reception may be based on the DL subframe timing. CCA timeslot may be defined by using the above described manner except for replacing OFDM symbol with Single carrier-frequency division multiple access (SC-FDMA) symbol.

For the UL transmission, in one approach, the same CCA timeslot for DL reception can be used. But the actual UL subframe transmission should consider the TA value and the association timing. Thus, a preamble may be added to the UL transmission to occupy the CCA timeslots before the actual UL subframe transmission when the UE 102 acquires the channel for transmission. Alternatively, the CCA timeslot for UL transmission may be adjusted with the same TA value.

The UE 102 may determine 206 the contention access region of the LAA cell. The CCA timeslot structure should be applied in a contention access region in LAA. There are several approaches to define a contention access region in LAA. In a first approach for defining a contention access region in LAA, the contention access region may start at any time in a subframe with any length. In this approach, the contention access region can start if the channel is clear for a long initial CCA timeslot after an occupied channel. The contention access region ends if the channel is occupied by other signals or the LAA node is transmitting. An occupied channel is a channel with any transmissions on the given unlicensed carrier. Thus, a LAA node will treat the channel as “occupied” if the node is transmitting or the CCA detection finds the channel is not clear.

In a second approach for defining a contention access region in LAA, the contention access region may be at fixed or configured locations in a subframe. In one alternative, the k OFDM symbols at the beginning of a subframe may be reserved as the contention access region, where k can be fixed or configured by higher layer signaling. For example, k may be 1, 2, or 3 OFDM symbols. The contention access region may be applicable only for the first LAA subframe transmission in a LAA subframe burst.

In another alternative, the k OFDM symbols at the end of a subframe may be reserved as the contention access region, where k can be fixed or configured by higher layer signaling. For example, k may be 1, 2, or 3 OFDM symbols. The contention access region may be applicable only for the last LAA subframe transmission in a LAA subframe burst. A contention access region may end if the channel is occupied by other signals or the LAA node is transmitting.

In a third approach for defining a contention access region in LAA, the contention access region is at a fixed or configured length after the channel is clear for a long initial CCA timeslot. In this approach, the contention access region can start if the channel is clear for a long initial CCA timeslot after a signal transmission or reception on a channel. The contention access region may have a fixed or configured length. For example, the contention access region may have a length of k OFDM symbols. The current OFDM symbol where the clear channel with a long initial CCA timeslot ends may be included as a part of the fixed or configured length of the contention access region. The current OFDM symbol where the clear channel with a long initial CCA timeslot ends may be added to the fixed or configured length of the contention access region. A contention access region ends if the channel is occupied by other signals or the LAA node is transmitting.

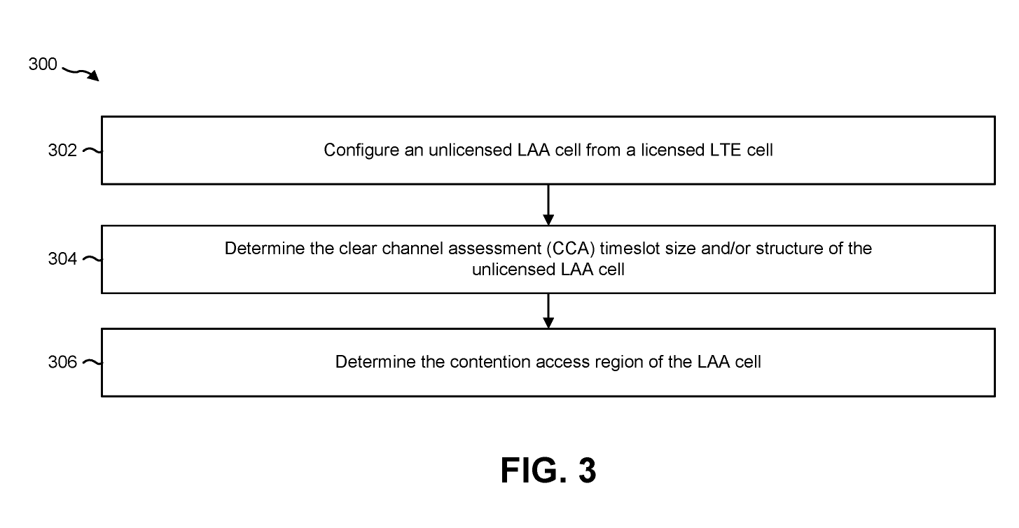

FIG. 3 is a flow diagram illustrating a method 300 for timeslot structure in LAA by an eNB 160. The eNB 160 may communicate with one or more UEs 102 in a wireless communication network. In one implementation, the wireless communication network may include an LTE network. The eNB 160 may configure 302 an unlicensed LAA cell from a licensed LTE cell.

The eNB 160 may determine 304 a clear channel assessment (CCA) timeslot size and/or structure of the unlicensed LAA cell. This may be accomplished as described in connection with FIG. 2.

The eNB 160 may determine 306 the contention access region of the LAA cell. This may be accomplished as described in connection with FIG. 2.

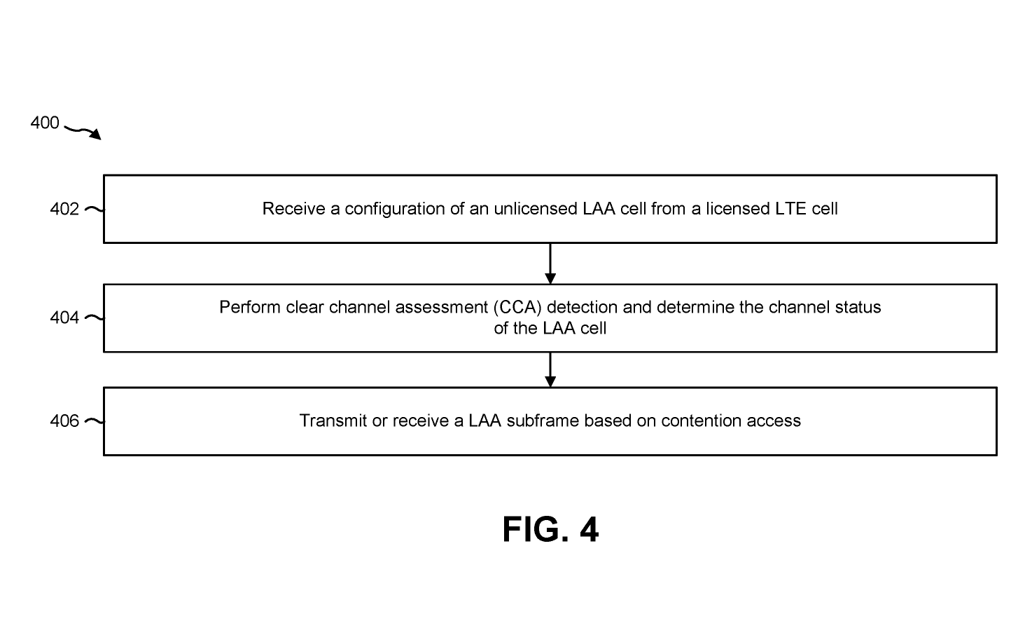

FIG. 4 is a flow diagram illustrating a method 400 for contention access in LAA by a UE 102. The UE 102 may communicate with one or more eNBs 160 in a wireless communication network. In one implementation, the wireless communication network may include an LTE network. The UE 102 may receive 402 a configuration of an unlicensed LAA cell from a licensed LTE cell.

The UE 102 may perform 404 CCA detection and may determine the channel status of the LAA cell. As described above, a LAA node may be an eNB 160 for DL transmission, or a LAA UE 102 that supports UL transmission on unlicensed carriers. A LAA node may be a LAA transmitting node, or a LAA receiving node. A LAA transmitting node may be a LAA eNB 160 performing DL transmissions on unlicensed carriers, or a LAA UE 102 performing UL transmissions on unlicensed carriers. A LAA receiving node may be a LAA UE 102 performing DL reception on unlicensed carriers, or a LAA eNB 160 performing UL reception on unlicensed carriers.

A LAA transmitting node may perform LBT and CCA before any transmission on an unlicensed carrier. The LAA transmitting node may transmit a LAA subframe burst after it acquires the channel access. On the other hand, a LAA receiving node may perform CCA to detect whether the channel is idle or busy. If the channel is busy, the LAA receiving node needs to identify the starting point of a LAA transmission and perform LAA subframe reception.

It should be noted that there is a difference between a CCA detection channel idle state and a LAA node channel IDLE state. To prevent interruption of 802.11 packet exchange, the LAA node may treat the channel as BUSY for initial CCA timeslots (i.e., multiple short CCA timeslots that depend on the LAA CCA timeslot structure) even if a CCA detection senses the channel as clear or idle in a CCA timeslot.

The state transmission for a LAA transmitting node is critical for a LAA operation, especially for a DL-only LAA network. When not transmitting, a LAA node should perform CCA detection in each short CCA timeslot. If the LAA node detects other transmissions, the channel is BUSY. If the LAA node detects that the channel is clear, but the CCA timeslot is within a long CCA timeslot after a previous busy CCA short timeslot, the LAA node may treat the channel as BUSY.

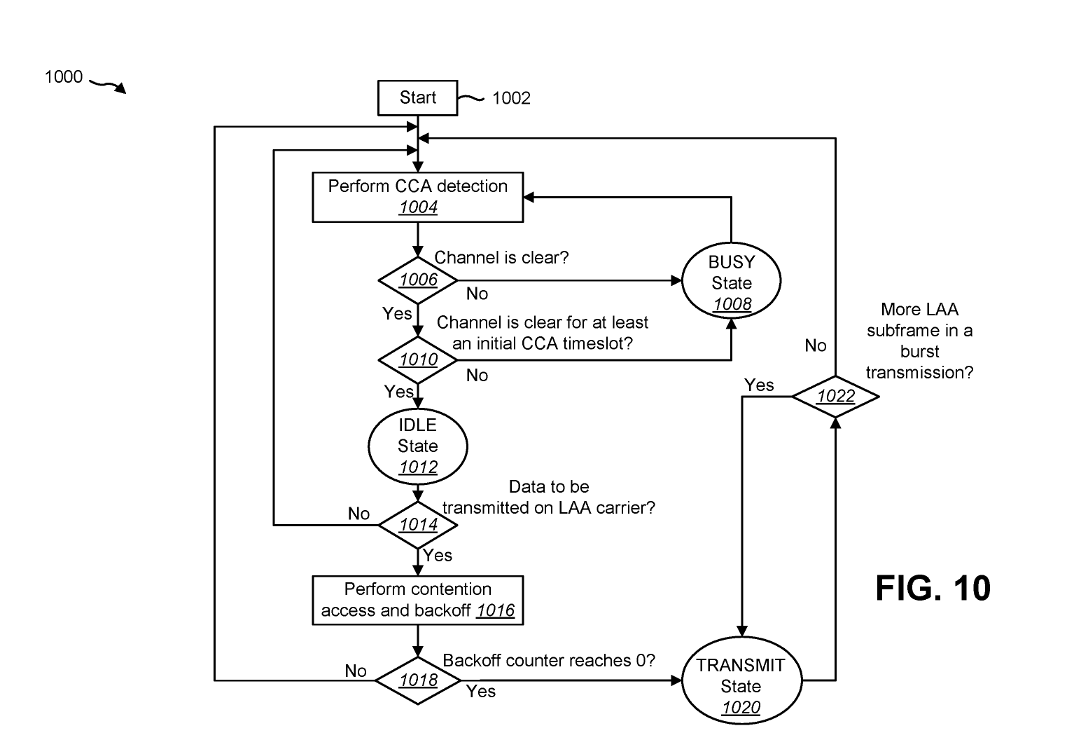

The channel may be regarded as IDLE if the LAA node does not detect any transmission for at least an initial CCA timeslot. If the channel is IDLE, the LAA node can perform contention access with backoff algorithms if there is data to be transmitted. When the LAA node acquires the channel, the node is in a TRANSMIT state. A LAA transmitting node may transmit a LAA burst of subframes based on the configuration that is compliant with regulatory requirements. FIG. 10 shows a diagram for the LAA transmitting node operations and state transitions.

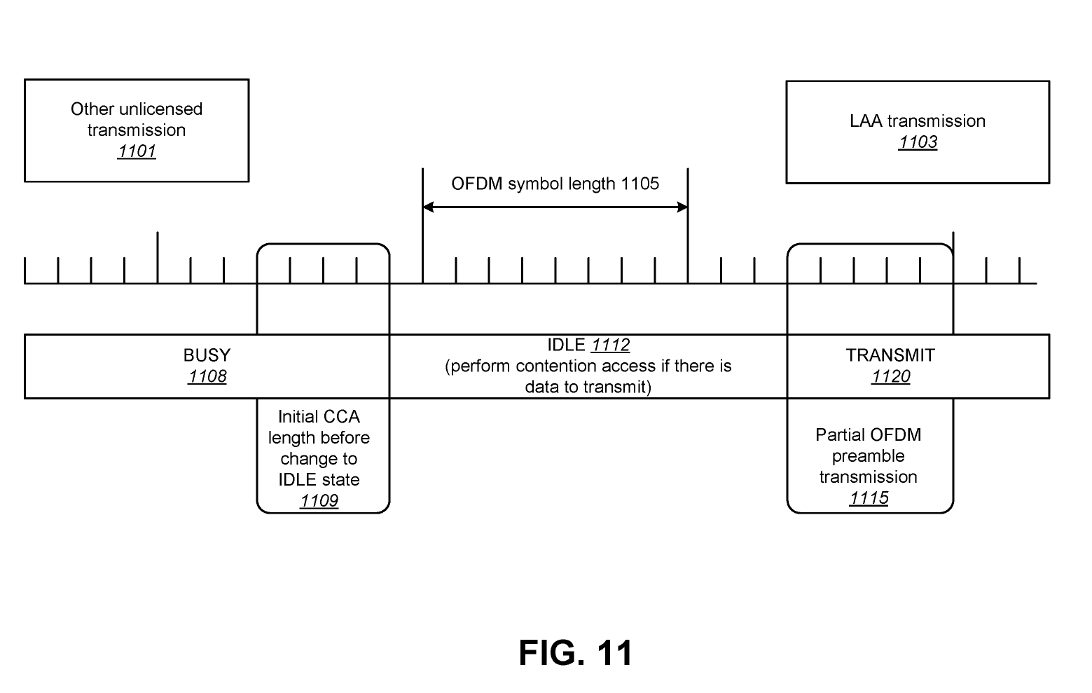

The synchronized CCA slot structure provides an easy state estimate and transition. FIG. 11 shows an example using LAA CCA timeslot structure of the first approach to an LAA CCA timeslot structure (as described above) in which an OFDM symbol is divided into 8 short CCA timeslots.

For a LAA receiving node, CCA detection should also be performed in each short CCA timeslot. If LAA receiving the node detects the channel is clear, the channel and LAA receiving node are in an IDLE state.

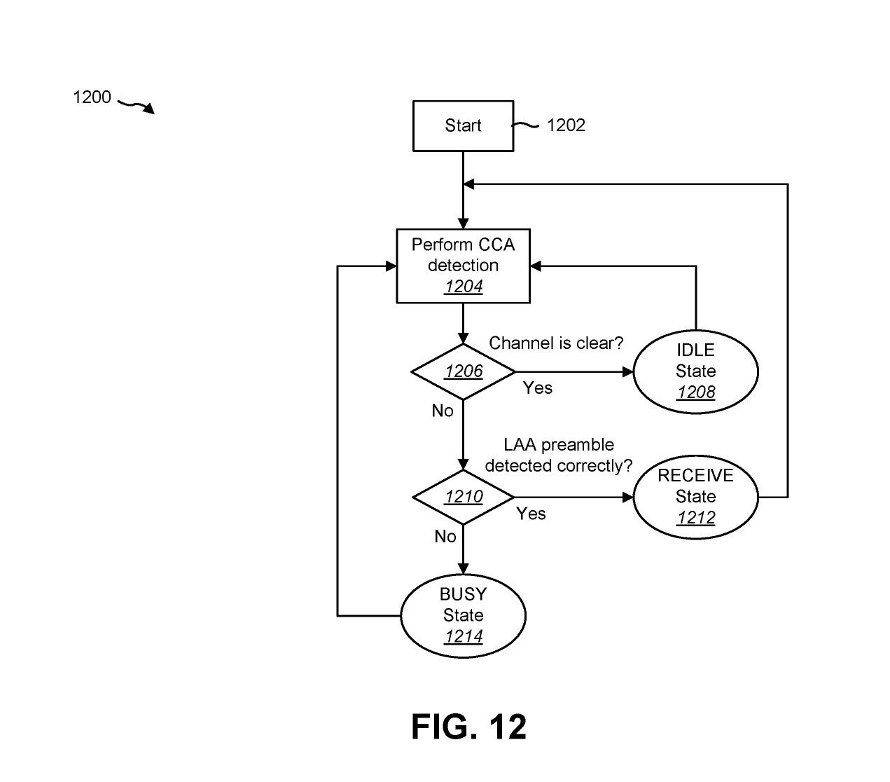

The fixed CCA timeslot size and boundary simplify the state transmission and signal detection at a LAA receiving node. When a LAA receiving node detects that the channel is busy (based on the CCA timeslot location, for instance), the LAA receiving node can detect the preamble based on how many CCA short timeslots are left in the current OFDM symbol length. If the preamble is detected correctly, the LAA receiving nodes should perform LAA reception for the rest of the transmission, and the LAA node is in RECEIVE mode. If the preamble is not detected correctly, the LAA receiving node may assume that there is another unlicensed transmission and the channel is in a BUSY state. FIG. 12 shows the operation and state transition of a LAA receiving node.

A LAA eNB 160 or a LAA UE 102 may be a LAA transmitting node and a LAA receiving nodes simultaneously. If the LAA network supports both UL and DL transmissions, a LAA node may perform as a transmitting node when it transmits subframes on the unlicensed carriers. Similarly, the LAA node may perform as a receiving node when it receives subframes on the unlicensed carrier. During the initial CCA detection (i.e., in the initial CCA slot), the LAA node may detect the channel as IDLE for a receiving perspective and as BUSY for a transmitting perspective.

If both UL and DL transmissions are supported in a LAA cell, the eNB 160 may perform receiving on the LAA cell. The LAA eNB 160 may schedule a UL transmission from a LAA UE 102. The LAA UE 102 should perform LBT and CCA before transmission at the scheduled subframe. The LAA UL transmission may be delayed or dropped if the UE 102 does not acquire the channel by contention access.

Although the examples described herein assume the CCA timeslot size and a synchronized structure defined in connection with FIG. 2, the same state transitions may be applied to other CCA timeslot sizes and CCA timeslots that are not synchronized with the OFDM symbols and LTE subframes.

The UE 102 may transmit or receive 406 a LAA subframe based on contention access. The channel access in an unlicensed band may be contention access from multiple nodes with the same or different air-interface technologies. Some backoff algorithms may be used to provide fairness and to reduce the collision probability.

The backoff algorithm design for LAA should take into account the differences between 802.11-based WiFi systems and LAA. For example, the backoff slot size of 802.11 and LAA may be different. The expected backoff time between two systems should be comparable for fair channel access. Furthermore, the number of stations in 802.11 and the number of LAA nodes may be different. The 802.11 protocol is designed to support a large number of stations. The number of LAA transmitting nodes in a LAA network can be very small, especially for DL-only use cases.

Additionally, the effective data transmissions of 802.11 and LAA may be different. The 802.11 packet transmission is not synchronized in time. However, because the LAA transmission follows the LTE subframe structure, a partial subframe transmission may not be useful, and may waste channel resources. On the other hand, the 802.11 protocol has a large overhead with packet exchanges and interframe spaces. The LAA has a much smaller overhead due to the assistance of the licensed carrier, especially for DL-only LAA use cases.

Different contention access and backoff approaches in a LAA transmitting node are described herein. In a first approach to contention access and backoff, an LAA node may perform a random backoff with a backoff counter. A LAA node can perform contention access with a random backoff algorithm where a contention window (CW) is defined and a backoff counter is used in the LAA node.

The backoff procedure starts when the LAA node senses the channel as IDLE as described above (i.e., the LAA node does not detect any transmission for at least an initial CCA timeslot). An initial backoff counter may be set with a value randomly chosen between (0, CW−1). The random value may be an integer number that is uniformly distributed between 0 and CW−1. For example, the random value may be generated by a modular function.

The backoff counter may be deducted by 1 if the LAA node senses a CCA timeslot is IDLE. The LAA node can transmit if the backoff counter reaches 0 and the channel state is IDLE at the beginning of the given slot.

The backoff counter is suspended if the LAA node senses the channel is BUSY (where the BUSY state is described above), and the initial CCA detection period after an unlicensed transmission is also BUSY. The backoff counter may resume if the channel becomes IDLE again.

In one alternative, the backoff contention window size is fixed, thus no exponential backoff is required. If the backoff counter reaches 0 but the channel is sensed as BUSY, the LAA node may backoff the transmission and reset the backoff counter again with a random value between (0, CW−1).

In another alternative, an exponential backoff is performed with an increased backoff contention window size. The initial backoff counter is chosen between (0, CW0−1), where CW0 is the initial CW size of LAA.

If the backoff counter reaches 0 but the channel is sensed as BUSY, the LAA node should backoff the transmission and reset the backoff counter again with a random value between (0, CWi−1). In this case, i is the i-th attempt of LAA transmission, CWᵢ=min(2ⁱ CW₀, CWₘₐₓ), and CWₘₐₓ is the maximum contention window size for LAA.

To determine the CW size for LAA, fairness between 802.11 and LAA should be considered. If the LAA CCA structure follows the first approach to an LAA CCA timeslot structure with 8 CCA timeslots in each OFDM symbol, as described in connection with FIG. 2, the sensing slot length is approximately the same as 802.11 at the 5 GHz band. Thus, the LAA initial CW size can be the same as the minimum contention window size of 802.11. Therefore, the initial CW size may be 32, and the initial backoff counter may be randomly chosen between (0, 31). The maximum CW size can be the same as 802.11 (i.e., 1024). The maximum CW size can also be a smaller value. For example, the maximum CW size may be chosen from 64, 128, 256 and 512.

If the LAA CCA structure follows the second approach to an LAA CCA timeslot structure with 4 CCA timeslots in each OFDM symbol, as described in connection with FIG. 2, the sensing slot length is approximately twice that of a backoff slot size of 802.11 at 5 GHz band. Thus, the LAA initial CW size should be half the minimum contention window size of 802.11. Therefore, the initial CW size may be 16, and the initial backoff counter may be randomly chosen between (0, 15). Accordingly, the maximum CW size may be 512 to maintain approximately the similar contention backoff length as 802.11.

On the other hand, since the CCA timeslot of LAA is longer than 802.11, LAA has less opportunity to access the channel than 802.11. For example, in a CCA timeslot, the LAA has only one chance to access the channel, but an 802.11 station may have 2 chances to access the channel. Therefore, the maximum CW size may be set with a smaller value. For example, the maximum CW size may be chosen from 32, 64, 128, or 256.

If a single CCA timeslot length is used, the CCA timeslot length may be configured as in the third approach to an LAA CCA timeslot structure as described in connection with FIG. 2 above. The CW size should be determined according to the configured CCA timeslot as described above.

The first approach to contention access and backoff corresponds to 802.11. Thus, a LAA transmission may start from any CCA timeslot in any OFDM symbol of a LTE subframe. In the current LTE downlink subframe, the transmission always starts at the subframe boundary, and all signals occupy full OFDM symbol length. Additionally, a DL subframe uses all OFDM symbols in a subframe. The downlink pilot time slot (DwPTS) in a special subframe of TDD LTE structure, starts at the subframe boundary and transmits multiple OFDM symbols depending on the special subframe configuration.

With a synchronized slot structure, the contention access and backoff procedures may be more predictable than that of 802.11. The first approach to contention access and backoff is also applicable if a simple backoff slot and CCA timeslot are defined for LAA without OFDM length or slot length synchronization.

To reduce the system complexity, other backoff approaches can be considered. In a second approach to contention access and backoff, a fixed LAA subframe structure or contention access region/length in a subframe may be used. In this approach, the LAA subframe structure is fixed for the initial or the last subframe in each LAA subframe burst. The subframe structure defines a reserved contention access region with a given length to perform contention access and backoff. The backoff window size may be determined dynamically based on the remaining length of the reserved contention access region after a LAA node determines the channel as IDLE.

In one implementation of this second approach, the first subframe of a LAA transmission uses a fixed subframe format. For example, k of the OFDM symbols at the beginning may be reserved for CCA and contention access. In another implementation of the second approach, the last subframe of the LAA transmission uses a fixed subframe format. For example, k of the OFDM symbols at the end of the last subframe may be reserved for CCA and contention access. The number of OFDM symbols reserved for contention access may be a fixed value (e.g., 1, 2 or 3 OFDM symbols), or configured by the eNB 160.

If the LAA node acquires the channel in the reserved period, a LAA subframe may be transmitted. The first LAA subframe is a reduced LTE subframe with fewer OFDM symbols produced by removing the reserved length for carrier sensing. A LAA preamble with partial OFDM symbol length may be used to reserve the channel from the time the LAA node acquires the channel to the subframe starting symbol defined by the fixed subframe format.

In one alternative, the backoff counter may be randomly chosen between 0 and the number of remaining CCA timeslots in the current OFDM symbol length. Therefore, the number of CCA timeslots from the channel may be sensed as IDLE to the beginning of the next OFDM symbol in a subframe. In another alternative, the backoff counter may be randomly determined based on CW, where the CW size is fixed or pre-defined or configured by higher layer signaling based on the length of the contention access region. The LAA node may sense the channel and perform CCA at each CCA timeslot. But the backoff procedure only performs at the beginning of a subframe within the given region. Thus, the CCA detection may be performed one long initial CCA timeslot before the reserved contention access region.

The state of IDLE may be determined as described above (i.e., the LAA node does not detect any transmission for at least an initial CCA timeslot). The contention window (CW) size may be determined by the number of CCA slots from the CCA time slot in the given region when the LAA node senses the channel as IDLE to the end of the contention access region. A backoff counter is initiated by random chosen between (0, CW−1).

The backoff counter is deducted by 1 if the LAA node senses a CCA timeslot as IDLE. The LAA node can transmit if the backoff counter reaches 0 and the channel state is IDLE at the beginning of the given slot.

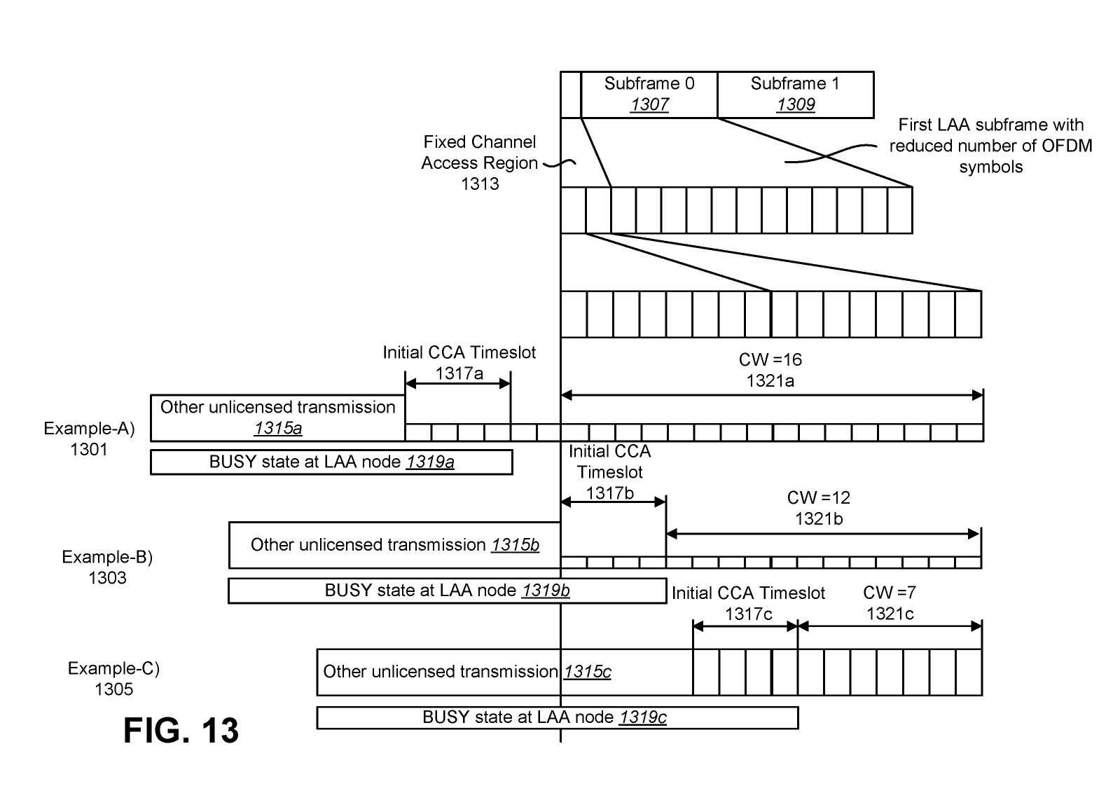

In this approach, the backoff counter is neither suspended nor resumed. Instead, a new backoff counter may be initialized at each instance of a channel access region. The backoff counter may be reset if the LAA node senses the channel is BUSY (where the BUSY state is determined as described above) and the initial CCA detection period after an unlicensed transmission is also BUSY. The backoff counter may be reset at each subframe. An example of a fixed contention access region and a dynamic backoff contention window is illustrated in FIG. 13.

The benefits of the second approach to contention access and backoff include a fixed subframe structure. Additionally, simpler contention access and reduced contention access region are also provided.

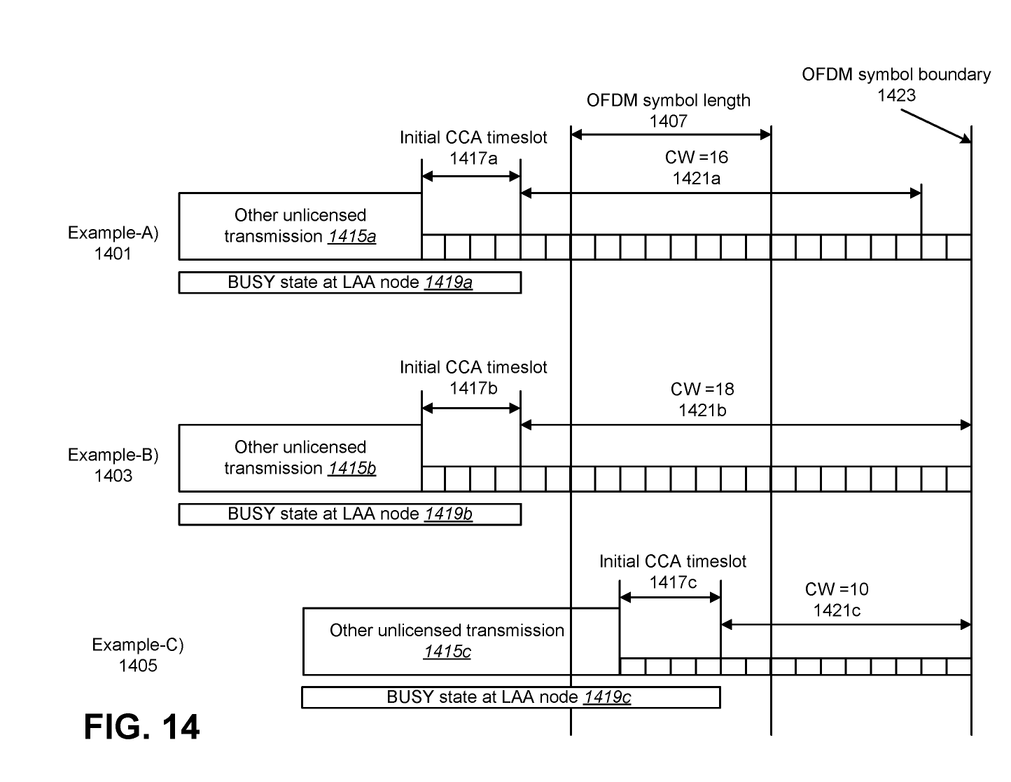

As a tradeoff, however, the second approach to contention access and backoff may reduce the opportunity a LAA node can contend for access. Therefore, in an alternative implementation, a LAA node may perform a contention access and backoff algorithm in a predefined contention access length after each time the channel is sensed as IDLE. In this implementation, three possible approaches can be used to determine the CW size. FIG. 14 illustrates the alternative approaches to apply a fixed length contention access region in LAA.

In a first approach to determine the CW size, a fixed length contention access region may be used immediately after the LAA node is in IDLE state. Thus, the CW size is also a fixed value. In this approach, the contention access region may start from the middle of an OFDM symbol length.

In a second approach to determine the CW size, a fixed length contention access region may be added after the current OFDM symbol length to form the contention access region for next access attempt. The number of remaining slots in the current OFDM symbol length may be added to the CW size.

In a third approach to determine the CW size, a fixed length contention access region may be applied inclusive of the current OFDM symbol length. The number of occupied BUSY CCA timeslots in the current OFDM symbol length may be subtracted from the CW size.

In a third approach to contention access and backoff, a CCA at the slot level and transmission at the OFDM symbol level may be used. Both the first and second approaches to contention access and backoff described above may use preamble transmissions with a partial OFDM length. To support a LAA transmission from a random CCA time slot, the LAA LTE needs to specify preambles with partial OFDM symbols with the granularity of the CCA timeslot. Additionally, the LAA LTE may specify subframe formats with any number of OFDM symbols within a subframe.

The current LTE symbol cannot be divided. Thus, special preamble signals may be designed for partial OFDM symbol transmissions. Yet, there is no clear method for how a UE 102 can transmit such a signal. Furthermore, a subframe with a reduced number of OFDM symbols may not be useful to carry data, thus it may waste resources.

Therefore, in the third approach to contention access and backoff, the LAA node (e.g., LAA eNB 160 or LAA UE 102) may only transmit at OFDM symbol boundaries, and all signals should be full OFDM symbols. With this approach, the CCA timeslot and the LAA transmission timeslot are separated. The LBT and CCA detection are performed with a smaller CCA timeslot. However, the actual transmission may be done at the OFDM symbol level. As a result, the backoff counter may be performed at OFDM symbol level, thus the CW size should be smaller with the third approach compared with the first and second approaches to contention access and backoff.

In a first implementation of the third approach to contention access and backoff, a similar contention access and backoff method as in the first approach described above can be used, except the backoff counter may be based on OFDM symbols. For example, the backoff counter may be reduced by 1 if the channel is idle for the whole OFDM symbol length (i.e., when all the CCA timeslots in the given OFDM symbol are idle). The LAA node may transmit if the channel is sensed idle and the backoff counter reaches 0.

Compared with the first approach to contention access and backoff, to maintain fairness with 802.11 channel accesses, the initial CW size and maximum CW size should be reduced in this first implementation of the third approach to contention access and backoff. The initial CW size may be 4 OFDM symbols, and the maximum CW size may be 128 OFDM symbols. The maximum CW size may be smaller due to a reduced chance of channel access. For example, the maximum CW size can be 8, 16, 32 or 64 symbols instead.

In a second implementation of the third approach to contention access and backoff, a similar contention access and backoff method as in the second approach described above can also be used, except the backoff counter may be based on OFDM symbols. The contention window size may be determined dynamically based on the time when the channel becomes IDLE.

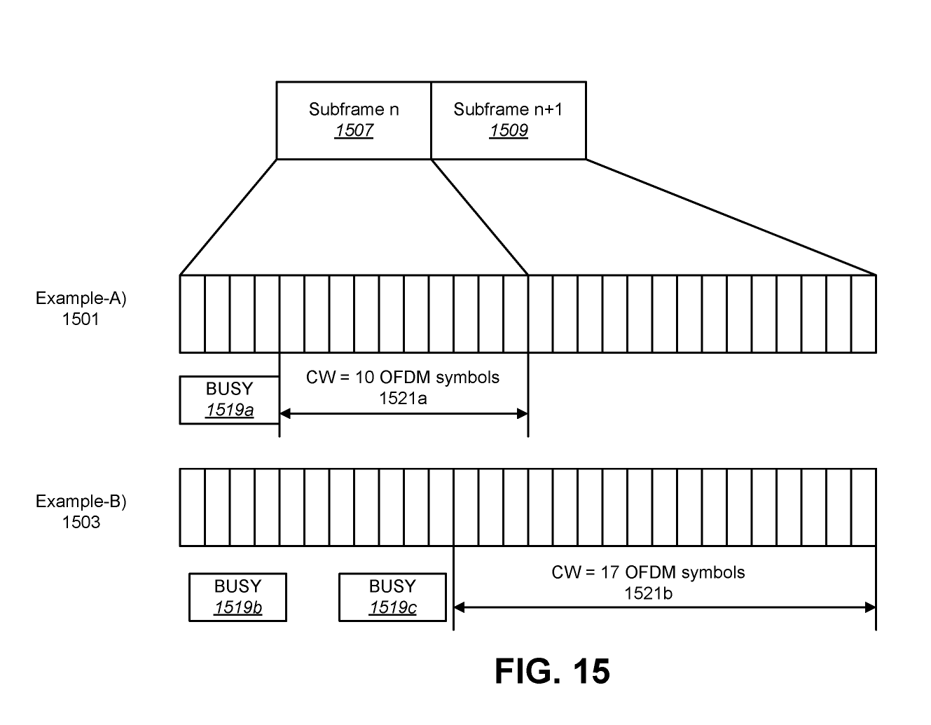

In one case, the contention access region may be defined as the region of the remaining OFDM symbols in a subframe. In another case, to reduce collision probability, the contention access region should be at least 4 symbols. Therefore, if the number of remaining OFDM symbols in a subframe is greater than or equal to 4, the contention access region is the region of remaining OFDM symbols in a subframe. If the number of remaining OFDM symbols in a subframe is less than 4, the contention access region is the region of the remaining OFDM symbols in a subframe and all OFDM symbols of the next subframe. FIG. 15 shows an example of the second implementation of the third approach to contention access and backoff.

In the second implementation of the third approach to contention access and backoff, the backoff counter may be reduced by 1 if the channel is idle for the whole OFDM symbol length. In other words, the backoff counter may be reduced by 1 when all the CCA timeslots in the given OFDM symbol are idle. The LAA node may transmit if the channel is sensed idle and the backoff counter reaches 0.

With the third approach to contention access and backoff, all LAA signals are full OFDM symbols. Therefore, no new signal format needs to be specified.

Although the approaches described in connection with this FIG. 4 assume the CCA timeslot size and a synchronized structure defined in connection with FIG. 2, the same approaches may be applied to other CCA timeslot sizes and CCA timeslots that are not synchronized with the OFDM symbols and LTE subframes.

Additionally, each LAA node may determine the above-mentioned random value in its own manner. Alternatively, the value may be pseudo-randomly derived in a common manner using a physical layer parameter or a higher layer parameter such as a physical cell identity, a transmission point identity, a system frame number and the like.

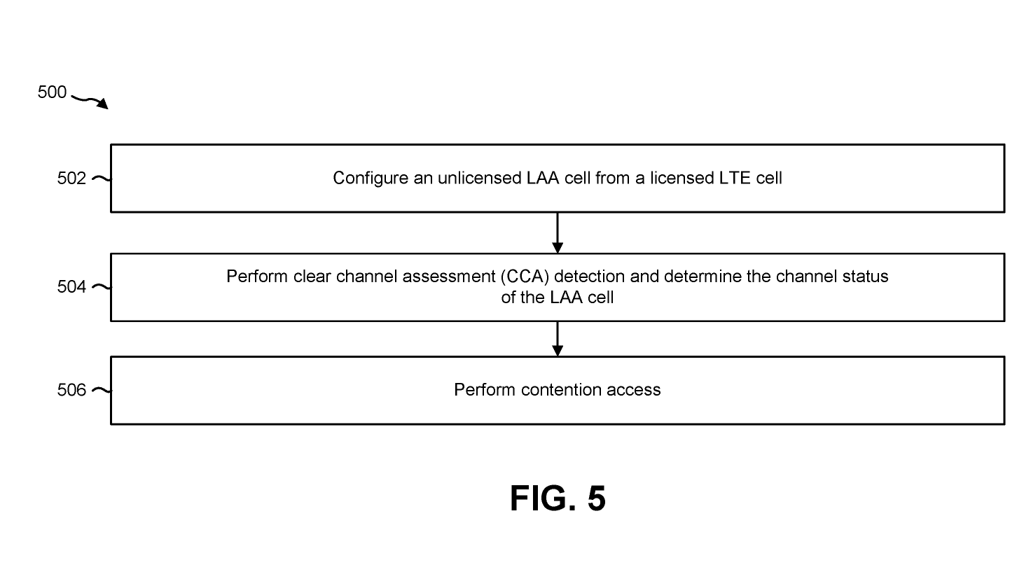

FIG. 5 is a flow diagram illustrating a method 500 for contention access in LAA by an eNB 160. The eNB 160 may communicate with one or more UEs 102 in a wireless communication network. In one implementation, the wireless communication network may include an LTE network. The eNB 160 may configure 502 an unlicensed LAA cell from a licensed LTE cell.

The eNB 160 may perform 504 CCA detection and determine the channel status of the LAA cell. This may be accomplished as described above in connection with FIG. 4.

The eNB 160 may perform 506 contention access. This may be accomplished as described above in connection with FIG. 4.

FIG. 6 illustrates an example of a LAA subframe burst transmission. This transmission may also be referred to as a LAA subframe set transmission. To provide fairness to other networks on the same unlicensed carrier, the eNB 160 may configure a maximum number of continuous subframe transmissions k in a LAA cell (e.g., a set of LAA subframes or a burst of LAA subframes 639). The maximum transmission time in an unlicensed carrier may be different in different regions and/or countries based on the regulatory requirements.

In this example, the subframe is configured with normal cyclic prefix. The first two OFDM symbol lengths are reserved for carrier sensing. Thus, subframe 0 in a set of LAA subframes is a subframe with a reduced number of symbols. A preamble with a partial OFDM length may be transmitted after a successful channel access in front of the first LAA subframe with a reduced number of OFDM symbols. No sensing is necessary for continuous LAA subframe transmission after the first LAA subframe. The regular LTE subframe structure may be applied on consecutive subframes in a LAA subframe set.

It should be noted that the subframe index number in FIG. 6 refers to the index in a LAA subframe burst, instead of the subframe index in a radio frame as in legacy LTE cells.

FIG. 7 illustrates an example of LAA coexistence with other unlicensed transmissions. A licensed serving cell 743 is shown with a 10 ms radio frame 741. A LAA serving cell 745 has LAA serving cell transmissions and other unlicensed transmissions (e.g., Wi-Fi or other LAA cells). Due to carrier sensing and deferred transmissions, the starting of a LAA transmission may be any subframe index in the radio frame 741 of the licensed frame structure.

FIG. 8 illustrates packet exchange sequences of a successfully delivered 802.11 packet. As described above, in 802.11 protocols used for WiFi transmissions, a short interframe space (SIFS) 849 may be used between consecutive packet transmissions (e.g., between a packet and the acknowledgment (ACK) 853 corresponding to it). The length of SIFS 849 in a 5 GHz band is 16 microseconds. Furthermore, all 802.11 stations have to wait for a distributed interframe space (DIFS) 855 before performing a backoff algorithm for channel access. FIG. 8 illustrates packet exchange sequences of a successfully delivered 802.11 packet with the distributed coordination function (DCF) when a request to send (RTS) 847 and clear to send (CTS) 851 is used.

In this case, a first SIFS 849a occurs after the RTS 847. A second SIFS 849b occurs after a first CTS 851a. A third SIFS 849c occurs after a second CTS 85 lb.

To avoid interruption of the 802.11 packet transmission protocol, the initial CCA timeslot for LAA may not be smaller than a SIFS 849. Furthermore, to provide fairness with 802.11, the initial CCA timeslot should be at least the length of a DIFS 855.

In 802.11 at the 5 GHz band, the SIFS 849 is 16 microseconds, and a DIFS 855 is 34 microseconds. The DIFS 855 length is determined by SIFS 849 plus two backoff timeslots (Tslot) 857, where the Tslot is 9 microseconds in 5 GHz band 802.11 systems.

FIG. 9 illustrates the CCA timeslot length and structure according to a first approach 901 and a second approach 903. In the first approach 901, a short CCA timeslot 961 is ⅛ for an OFDM symbol 959a length. Therefore, there may be 8 short CCA timeslots 961 in one OFDM symbol 959a. In one implementation of the first approach 901, the initial CCA timeslot length 963 (e.g., long CCA timeslot) is 4 times the short CCA timeslot 961. In another implementation of the first approach 901, the initial CCA timeslot length 963 (e.g., long CCA timeslot) is 2 times the short CCA timeslot 961.

In the second approach 903, a short CCA timeslot 961 is ¼ for an OFDM symbol 959b length. Therefore, there may be 4 short CCA timeslots 961 in one OFDM symbol 959b. In one implementation of the second approach 903, the initial CCA timeslot length 963 (e.g., long CCA timeslot) is 2 times the short CCA timeslot 961. In another implementation of the second approach 903, the initial CCA timeslot length 963 (e.g., long CCA timeslot) is the same as the short CCA timeslot 961.

FIG. 10 is a flow diagram illustrating a method 1000 for LAA transmitting node operations and state transitions. The method 1000 may be performed by an LAA node. The LAA node may be an eNB 160 or a UE 102. Upon starting 1002 the method 1000, the LAA node may perform 1004 CCA detection. When not transmitting, the LAA node should perform CCA detection in each short CCA timeslot.

If the LAA node determines 1006 that the channel is not clear, then the LAA may enter a BUSY state 1008. In other words, if the LAA node detects other transmissions, the channel is BUSY. The LAA node may then perform 1004 CCA detection.

If the LAA node determines 1006 that the channel is clear, the LAA node may determine 1010 whether the channel is clear for at least an initial CCA timeslot. If the LAA node detects the channel is clear, but the CCA timeslot is within a long CCA timeslot after a previous busy CCA short timeslot, the LAA node treats the channel as BUSY and enters the BUSY state 1008.

If the LAA node determines 1010 that the channel is clear for at least an initial CCA timeslot, then the LAA node may enter an IDLE state 1012. The channel may be regarded as IDLE if the LAA node does not detect any transmission for at least an initial CCA timeslot.

If the LAA node determines 1014 that there is data to be transmitted on the LAA carrier, the LAA node may perform 1016 contention access with backoff algorithms. This may be accomplished as described above in connection with FIG. 4. If there is no data to be transmitted, then the LAA node may continue to perform 1004 CCA detection.

The LAA node may determine 1018 whether a backoff counter reaches 0. The backoff counter may be set, reset, decremented and incremented as described in connection with FIG. 4. If the backoff counter is greater than 0, the LAA node may continue to perform 1004 CCA detection.

When the backoff counter reaches 0, then the LAA node may enter a TRANSMIT state 1020. When the LAA node acquires the channel, the node is in TRANSMIT state. The LAA node may transmit a LAA burst of subframes based on the configuration that is compliant with regulatory requirements.

The LAA node may determine 1022 whether there are more LAA subframes in a burst transmission. If there are additional LAA subframes, the LAA node may continue in the TRANSMIT state 1020 and transmit the LAA subframes. If the LAA node determines 1022 that are no more LAA subframes in the burst transmission, then the LAA node may perform 1004 CCA detection and enter either a BUSY state 1008 or an IDLE state 1012.

FIG. 11 illustrates an example of LAA transmitting node state transitions. In particular, FIG. 11 shows using the LAA CCA timeslot structure of the first approach to an LAA CCA timeslot structure in which an OFDM symbol length 1105 is divided into 8 short CCA timeslots, as described in connection with FIG. 2.

The LAA node considers the channel as BUSY 1108 during the initial CCA length of other unlicensed transmission 1101, which is 4 short CCA timeslots in this example with the structure of the first approach (2 short CCA timeslots if structure of the second approach is applied). After the initial CCA length 1109, the LAA node may switch to IDLE state 1112. While in an IDLE state 1112, the LAA node may perform contention access if there is data to transmit.

When the LAA node enters a TRANSMIT state 1120, the LAA node may start an LAA transmission 1103. The starting part may be a partial OFDM preamble 1115 if the starting point is not at an OFDM boundary. The fixed CCA timeslot size and boundary simplify the preamble design because only 8 different preamble lengths are needed instead of a random length when the CCA timeslot is not synchronized.

FIG. 12 is a flow diagram illustrating a method 1200 for LAA receiving node operations and state transitions. The method 1200 may be performed by an LAA node. The LAA node may be an eNB 160 or a UE 102. Upon starting 1202 the method 1200, the LAA node may perform 1204 CCA detection. When not receiving, the LAA node should perform 1204 CCA detection in each short CCA timeslot.

If the LAA node determines 1206 that the channel is clear, then the LAA may enter an IDLE state 1208. In other words, if the LAA node does not detect other transmissions, the channel and LAA node may be in an IDLE state 1208. The LAA node may then perform 1204 CCA detection.

If the LAA node determines 1206 that the channel is not clear, the LAA node may determine 1210 whether an LAA preamble is detected correctly. When a LAA receiving node detects the channel is busy, based on the CCA timeslot location, the LAA node can detect the LAA preamble based on how many CCA short timeslots are left in the current OFDM symbol length.

If the LAA preamble is detected correctly, the LAA node may enter a RECEIVE state 1212. The LAA node may perform LAA reception for the rest of the transmission. The LAA node may then perform 1204 CCA detection.

If the LAA preamble is not detected correctly, the LAA node may enter a BUSY state. The LAA node may assume there is another unlicensed transmission and the channel is in a BUSY state 1214. The LAA node may then perform 1204 CCA detection.

FIG. 13 illustrates a fixed contention access region and a dynamic backoff contention window. This Figure illustrates the second approach to contention access and backoff, as described above in connection with FIG. 4. In this example, the subframes 0 and 1 are normal CP subframes. Furthermore, k is 2 OFDM symbols and each OFDM symbol consists of 8 short CCA timeslots.

In FIG. 13, the first LAA subframe 1307 (i.e., subframe 0) has a reduced number of OFDM symbols. Therefore, instead of 14 OFDM symbols, subframe 0 has 12 OFDM symbols. The first two OFDM symbols are a reserved region for carrier sensing. This region is referred to as a fixed contention access region 1313 or channel access region. FIG. 13 shows how the CW 1321 is calculated for each fixed contention access region 1313.

In Example-A 1301, the other unlicensed transmission 1315a is occurring followed by an initial CCA timeslot 1317a. During this period, the LAA node is in a BUSY state 1319a. In this example 1301, the channel is IDLE at the beginning of the fixed contention access region 1313. Therefore, the CW size 1321a is the total number of CCA timeslots in the contention access region. In this example, the CW size 1321a is 16 CCA timeslots.

In Example-B 1303, the other unlicensed transmission 1315b is occurring followed by an initial CCA timeslot 1317b. During this period, the LAA node is in a BUSY state 1319b. In this example 1303, the channel is in a BUSY state 1319b at the beginning of the fixed contention access region 1313. In this case, the other unlicensed transmission 1315b ends at the beginning of the fixed contention access region 1313. However, the channel BUSY state 1319b covers part of the fixed contention access region 1313 due to the initial CCA timeslot 1317b. Thus, the CW size 1321b becomes smaller than in Example-A 1301. In this example 1303, the CW size 1321b is 12 CCA timeslots.

In Example-C 1305, the channel is in a BUSY state 1319c at the beginning of the fixed contention access region 1313. In this case, the other unlicensed transmission 1315c overlaps the beginning of the fixed contention access region 1313. Additionally, the channel BUSY state 1319c further extends into the contention access region 1313 due to the initial CCA timeslot 1317c. In this example 1305, the CW size 1321c is 7 CCA timeslots.

FIG. 14 illustrates alternatives to apply a fixed contention access region and a dynamic backoff contention window. This Figure illustrates alternative implementations of the second approach to contention access and backoff, as described above in connection with FIG. 4. In FIG. 14, three examples are shown. In these examples, the fixed length contention access region is two OFDM symbols. The end of the two OFDM symbols is an OFDM symbol boundary 1423. Each OFDM symbol has an OFDM symbol length 1407 divided into 8 CCA timeslots.

In Example-A 1401, the other unlicensed transmission 1415a is followed by an initial CCA timeslot 1417a of 4 timeslots. The channel is in a BUSY state 1419a until two timeslots before the fixed length contention access region. In this case, the fixed length contention access region is applied immediately after the LAA node is in IDLE state. Thus, the CW size 1421a is always 16 CCA timeslots.

In Example-B 1403, the other unlicensed transmission 1415b is followed by an initial CCA timeslot 1417b of 4 timeslots. The channel is in a BUSY state 1419b until two timeslots before the fixed length contention access region. In this case, the fixed length contention access region is applied immediately after the LAA node is in IDLE state. The remaining two CCA timeslots in the current OFDM symbol length 1407 are added to the fixed length contention access region. Thus, the CW size 1421b becomes 18 CCA timeslots for this access attempt.

In Example-C 1405, the channel is in a BUSY state 1419c at the beginning of the fixed contention access region. In this case, the other unlicensed transmission 1415c overlaps the beginning of the fixed contention access region. Additionally, the channel BUSY state 1419c further extends into the contention access region due to the initial CCA timeslot 1417c. The current OFDM symbol length 1407 is included within the fixed contention access region, and the CCA timeslots 1417c with BUSY states are excluded in the CW size 1421c calculation. Thus, the CW size 1421c is only 10 CCA timeslots in this example.

FIG. 15 illustrates one implementation of an approach to contention access and backoff. Specifically, FIG. 15 shows an example of the second implementation of the third approach to contention access and backoff described in connection with FIG. 4. In the third approach to contention access and backoff, a CCA at the slot level and transmission at the OFDM symbol level may be used.

In FIG. 15, two examples are shown. In the second implementation of the third approach to contention access and backoff, the backoff counter may be based on OFDM symbols. The contention window size 1521 may be determined dynamically based on the time when the channel becomes IDLE. The subframes 1507, 1509 in FIG. 15 assume normal CP and each have 14 OFDM symbols.

In Example-A 1501, the current subframe 1507 (i.e., subframe n) is BUSY 1519a for 4 symbols. Therefore, the remaining region of the current subframe 1507 (i.e., subframe n) is more than 4 symbols. In this case, the CW 1521a is determined by the remaining number of OFDM symbols in the current subframe 1507. The CW 1521a is 10 OFDM symbols in Example-A 1501.

In Example-B 1503, the current subframe 1507 (i.e., subframe n) is BUSY 1519b, 1519c for 11 symbols. Therefore, the remaining region of the current subframe 1507 is less than 4 symbols. The CW 1521b is determined by the sum of the remaining number of OFDM symbols of the current subframe 1507 (i.e., subframe n) and the number of OFDM symbols of the next subframe 1509 (i.e., subframe n+1). The CW 1521b is 17 OFDM symbols in Example-B 1503.

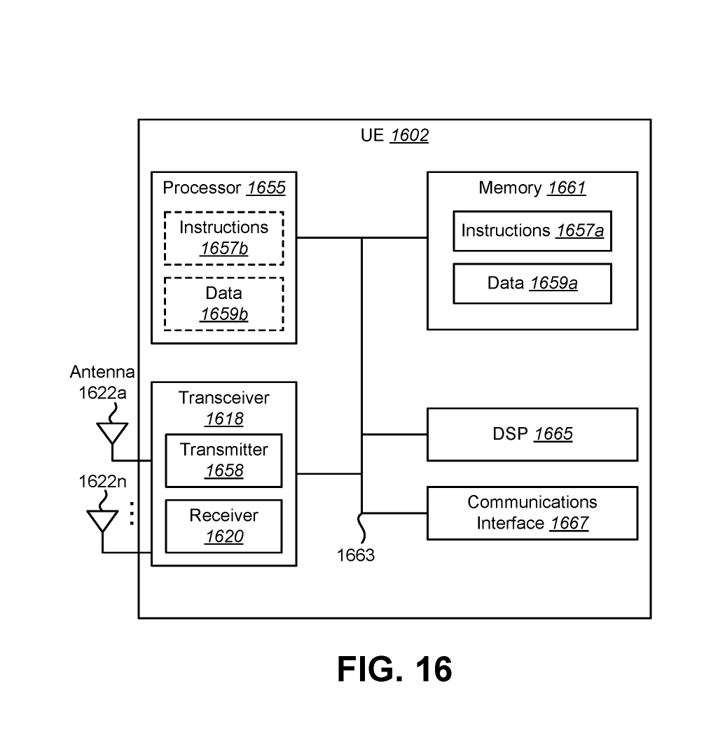

FIG. 16 illustrates various components that may be utilized in a UE 1602. The UE 1602 described in connection with FIG. 16 may be implemented in accordance with the UE 102 described in connection with FIG. 1. The UE 1602 includes a processor 1655 that controls operation of the UE 1602. The processor 1655 may also be referred to as a central processing unit (CPU). Memory 1661, which may include read-only memory (ROM), random access memory (RAM), a combination of the two or any type of device that may store information, provides instructions 1657a and data 1659a to the processor 1655. A portion of the memory 1661 may also include non-volatile random access memory (NVRAM). Instructions 1657b and data 1659b may also reside in the processor 1655. Instructions 1657b and/or data 1659b loaded into the processor 1655 may also include instructions 1657a and/or data 1659a from memory 1661 that were loaded for execution or processing by the processor 1655. The instructions 1657b may be executed by the processor 1655 to implement one or more of the method 200 and 400 described above.

The UE 1602 may also include a housing that contains one or more transmitters 1658 and one or more receivers 1620 to allow transmission and reception of data. The transmitter(s) 1658 and receiver(s) 1620 may be combined into one or more transceiver(s) 1618. One or more antennas 1622a-n are attached to the housing and electrically coupled to the transceiver(s) 1618.

The various components of the UE 1602 are coupled together by a bus system 1663, which may include a power bus, a control signal bus and a status signal bus, in addition to a data bus. However, for the sake of clarity, the various buses are illustrated in FIG. 16 as the bus system 1663. The UE 1602 may also include a digital signal processor (DSP) 1665 for use in processing signals. The UE 1602 may also include a communications interface 1667 that provides user access to the functions of the UE 1602. The UE 1602 illustrated in FIG. 16 is a functional block diagram rather than a listing of specific components.

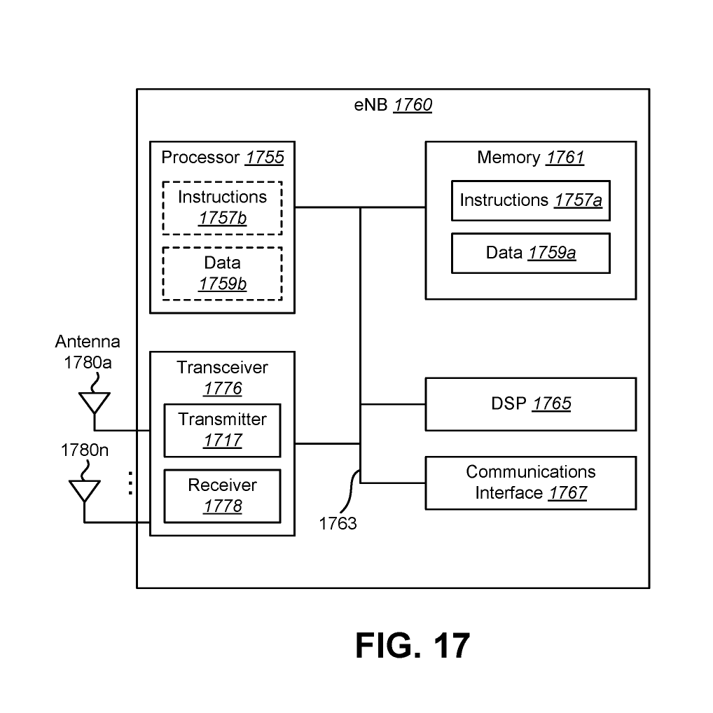

FIG. 17 illustrates various components that may be utilized in an eNB 1760. The eNB 1760 described in connection with FIG. 17 may be implemented in accordance with the eNB 160 described in connection with FIG. 1. The eNB 1760 includes a processor 1755 that controls operation of the eNB 1760. The processor 1755 may also be referred to as a central processing unit (CPU). Memory 1761, which may include read-only memory (ROM), random access memory (RAM), a combination of the two or any type of device that may store information, provides instructions 1757a and data 1759a to the processor 1755. A portion of the memory 1761 may also include non-volatile random access memory (NVRAM). Instructions 1757b and data 1759b may also reside in the processor 1755. Instructions 1757b and/or data 1759b loaded into the processor 1755 may also include instructions 1757a and/or data 1759a from memory 1761 that were loaded for execution or processing by the processor 1755. The instructions 1757b may be executed by the processor 1755 to implement one or more of the method 300 and 500 described above.

The eNB 1760 may also include a housing that contains one or more transmitters 1717 and one or more receivers 1778 to allow transmission and reception of data. The transmitter(s) 1717 and receiver(s) 1778 may be combined into one or more transceiver(s) 1776. One or more antennas 1780a-n are attached to the housing and electrically coupled to the transceiver(s) 1776.

The various components of the eNB 1760 are coupled together by a bus system 1763, which may include a power bus, a control signal bus and a status signal bus, in addition to a data bus. However, for the sake of clarity, the various buses are illustrated in FIG. 17 as the bus system 1763. The eNB 1760 may also include a digital signal processor (DSP) 1765 for use in processing signals. The eNB 1760 may also include a communications interface 1767 that provides user access to the functions of the eNB 1760. The eNB 1760 illustrated in FIG. 17 is a functional block diagram rather than a listing of specific components.

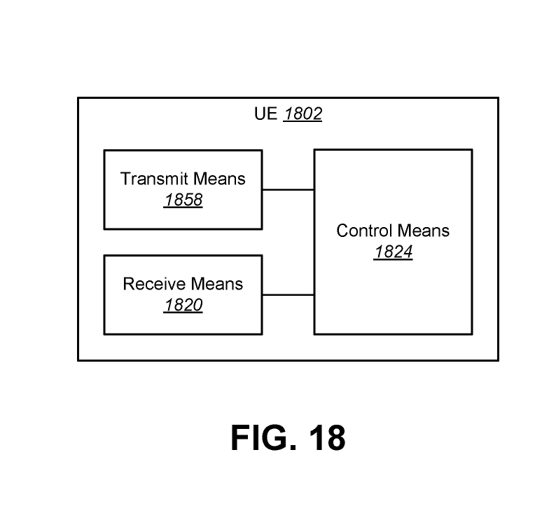

FIG. 18 is a block diagram illustrating one implementation of a UE 1802 in which systems and methods for performing LAA may be implemented. The UE 1802 includes transmit means 1858, receive means 1820 and control means 1824. The transmit means 1858, receive means 1820 and control means 1824 may be configured to perform one or more of the functions described in connection with FIG. 1 above. FIG. 23 above illustrates one example of a concrete apparatus structure of FIG. 18. Other various structures may be implemented to realize one or more of the functions of FIG. 1. For example, a DSP may be realized by software.

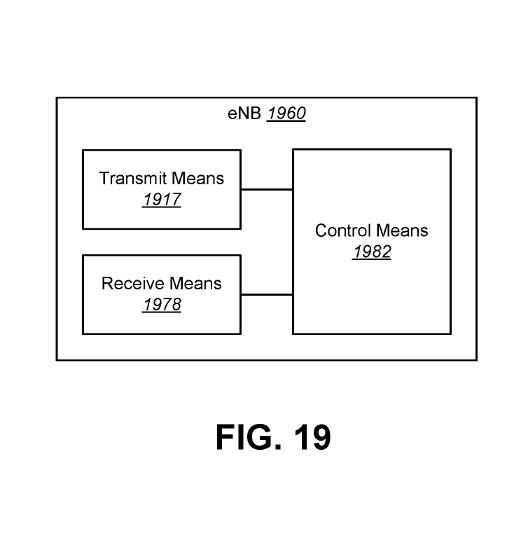

FIG. 19 is a block diagram illustrating one implementation of an eNB 1960 in which systems and methods for performing LAA may be implemented. The eNB 1960 includes transmit means 1917, receive means 1978 and control means 1982. The transmit means 1917, receive means 1978 and control means 1982 may be configured to perform one or more of the functions described in connection with FIG. 1 above. FIG. 24 above illustrates one example of a concrete apparatus structure of FIG. 19. Other various structures may be implemented to realize one or more of the functions of FIG. 1. For example, a DSP may be realized by software.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

A program running on the eNB 160 or the UE 102 according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or HDDs, and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD, and the like), a magnetic storage medium (for example, a magnetic tape, a flexible disk, and the like), and the like, any one may be possible. Furthermore, in some cases, the function according to the described systems and methods described above is realized by running the loaded program, and in addition, the function according to the described systems and methods is realized in conjunction with an operating system or other application programs, based on an instruction from the program.

Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the eNB 160 and the UE 102 according to the systems and methods described above may be realized as an LSI that is a typical integrated circuit. Each functional block of the eNB 160 and the UE 102 may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

What is claimed is:

1. A communication device comprising:
a processor; and
memory in electronic communication with the processor, wherein instructions stored in the memory are executable to:
configure a license-assisted-access (LAA) cell;
determine a region for CCA slots and contention access;
generate a backoff counter based on a contention window size N;
perform clear channel assessment (CCA) detection;
decrement the backoff counter if the channel is idle in a concerned one of the CCA slots; and
transmit at least one subframe after the CCA slots if the backoff counter reaches zero within the region for CCA slots.

2. The communication device of claim 1, wherein
The CCA slots are located in k symbol(s) at an end of a subframe, k being either one of 1, 2, and 3.

3. The communication device of claim 1, wherein
The number of the CCA slots within the region is equal to N.

4. A method performed in a communication device, the method comprising:
configuring a license-assisted-access (LAA) cell;
determining a region for CCA slots and contention access;
generating a backoff counter based on a contention window size N;
performing clear channel assessment (CCA) detection;
decrementing the backoff counter if the channel is idle in a concerned one of the CCA slots; and
transmitting at least one subframe after the CCA slots if the backoff counter reaches zero within the region for CCA slots.

5. The method of claim 4, wherein
The CCA slots are located in k symbol(s) at an end of a subframe, k being either one of 1, 2, and 3.

6. The method of claim 4, wherein
The number of the CCA slots within the region is equal to N.
